(19) United States
(12) Patent Application Publication
(10) Pub. No.: US 2012/0200561 A1
(43) Pub. Date: Aug. 9, 2012

(54) DISPLAY APPARATUS, DISPLAY CONTROL APPARATUS, AND DISPLAY CONTROL METHOD

(75) Inventor: Makoto BANDO, Kawasaki (JP)

(73) Assignee: FUJITSU LIMITED, Kawasaki-shi (JP)

(21) Appl. No.: 13/367,240

(22) Filed: Feb. 6, 2012

(30) Foreign Application Priority Data
Feb. 9, 2011 (JP) 2011-025759

(51) Int. Cl. G06T 15/00

(52) U.S. Cl. 345/419

(57) ABSTRACT

There is provided a display apparatus including a display configured to display an image in accordance with data for a three dimensional image, a filter configured to receive the displayed image from the display and to transform the displayed image to a stereoscopic image while the displayed image transmitting through the filter, where the filter is operable to be set to be attachable to and detachable from the display, and a detector configured to detect whether the filter is set to the display or not.

### CROSS-REFERENCE TO RELATED APPLICATION

This application is based upon and claims the benefit of priority of the prior Japanese Patent Application No. 2011-025759, filed on Feb. 9, 2011, the entire contents of which are incorporated herein by reference.

### FIELD

The embodiments discussed herein are related to a display apparatus, a display control apparatus, and a display control method.

### BACKGROUND

As a means to allow a viewer to three-dimensionally perceive 3D images or pictures displayed on a display apparatus, a viewer may wear a polarized device, or a 3D display device may be set for a display apparatus. As the polarized device for allowing a viewer to perceive 3D images three-dimensionally, a pair of polarized glasses, for example, is utilized. Parallax images based on different polarizing states pass through a pair of polarized glasses so that a left-eye image is viewed with a left eye and a right-eye image is viewed with a right eye, thereby allowing a viewer to recognize 3D images. As a means to allow a viewer to recognize 3D images with the naked eyes, as stated above, a 3D display device may be set for a display apparatus. As a method for viewing 3D images by using such a 3D display device, a parallax barrier system and a lenticular lens system are known.

As a 3D display device set for a display apparatus, the following display device, for example, is disclosed in Japanese Laid-open Patent Publication No. 2005-215161. In this display device, a frame for attaching a 3D filter to the frame is provided for a display unit. This frame includes a positioning mechanism for attachably and detachably supporting the 3D filter and for positioning the 3D filter.

As a unit for allowing a screen filter to be attachable to and detachable from a display apparatus, the following device, for example, is disclosed in Japanese Examined Patent Application Publication No. 2579005. Tabs are provided in the vicinity of both ends of the top portion or the bottom portion of a filter, and a tab is also provided around the center of the bottom portion or the top portion of the filter. Notches are provided at the corresponding positions at the periphery of a cabinet of a display apparatus so as to receive the tabs of the filter.

Additionally, as multilayered optical sheets disposed on a display apparatus, for example, a multilayered body including optical sheets is disclosed in Japanese Laid-open Patent Publication No. 2009-42632. In this multilayered body, a front layer optical sheet and a back layer optical sheet are provided with engaging portions, and an intermediate optical sheet is inserted between the front layer optical sheet and the back layer optical sheet.

### SUMMARY

According to an aspect of the invention, a display apparatus includes a display configured to display an image in accordance with data for a three dimensional image, a filter configured to receive the displayed image from the display and to transform the displayed image to a stereoscopic image while the displayed image transmitting through the filter, where the filter is operable to be set to be attachable to and detachable from the display, and a detector configured to detect whether the filter is set to the display or not.

According to another aspect of the invention, a method executed by a processer for displaying an image includes monitoring, by the processer, whether a filter is fixed or not in front of a display, the display being operable to display a three dimensional image in a three dimensional mode, detecting a status in which the filter is fixed in front of the display, and shifting a mode of the display to the three dimensional mode according to the detected status.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the configuration of a display apparatus according to a first embodiment;

FIG. 2 illustrates an example of the external configuration of a personal computer (PC) according to a second embodiment;

FIG. 3 illustrates an example of the attachment/detachment state of a filter panel;

FIG. 4 is a partial view in section taken along line IV-IV of FIG. 2;

FIGS. 5A and 5B are side views illustrating examples of the attachment/detachment state of the filter panel;

FIG. 6 is a sectional view taken along line VI-VI of FIG. 2;

FIG. 7 is a sectional view illustrating an example of the bottom portion of a display unit;

FIG. 8 illustrates an example of the configuration of the display unit and surrounding components thereof;

FIG. 9 is an exploded view illustrating an example of the configuration of the display unit and the surrounding components thereof;

FIG. 10 illustrates an example of the configuration of the filter panel;

FIG. 11 illustrates an example of the configuration of a frame;

FIG. 12 illustrates an example of the configuration of a lock slider;

FIG. 13 illustrates an example of the configurations of the lock slider and a switch;

FIGS. 14A and 14B illustrate an example of the state in which the filter pane is being held against the display unit;

FIGS. 15A through 16B illustrate an example of an operation of the lock slider when the filter panel is attached;

FIGS. 17A through 17C illustrate an example of an operation of the lock slider when the filter panel is detached;

FIG. 18 illustrates an example of the functional configuration of an attachment/detachment detector;

FIG. 19 illustrates an example of the configuration of a display control function;

FIG. 20 illustrates an example of the hardware configuration of a PC;

FIG. 21 is a flowchart illustrating an example of display control processing;

FIG. 22 is a flowchart illustrating an example of 2D/3D image switching processing;

FIG. 23 is a flowchart illustrating an example of 3D image extracting processing and display processing;

FIGS. 24A through 24C illustrate examples of identification information contained in 3D image information;

FIG. 25 illustrates another example of identification information contained in 3D image information;

FIG. 26 illustrates an example of an electronic apparatus according to another embodiment;

FIG. 27 illustrates an example of the configuration of a PC according to another embodiment; and

FIG. 28 is a flowchart illustrating another example of 2D/3D image switching processing.

### DESCRIPTION OF EMBODIMENTS

Preliminary Consideration

The major type of conventional 3D filter panel provided for a display apparatus is a fixed-type filter panel, which is to be fixed to a display apparatus. By the use of such a fixed-type filter panel, when viewing 2D images, which do not support 3D display, a viewer has to view 2D images through the 3D filter panel, thereby reducing the screen resolution or the brightness of display images.

Additionally, once such a fixed-type filter panel is attached to a display apparatus, it is difficult to detach it from the display apparatus, which makes it difficult to utilize the single display apparatus both for 2D and 3D images. Moreover, it is necessary to check whether an image program to be executed by using this display apparatus is 2D or 3D, thereby increasing the complexity of an execution (playback) operation.

The above-described publications neither disclose nor suggest such requirements and problems, or configurations for satisfying such requirements or solving such problems.

Accordingly, it is desired to provide a display apparatus, a display control apparatus, a display control method, and an electronic apparatus in which a polarizing filter panel, which allows a viewer to three-dimensionally perceive 3D images, is configured to be attachable to and detachable from a display apparatus, and the attachment/detachment state of the polarizing filter panel is monitored so as to optimize switching between 2D display and 3D display.

It is desired as well to provide a display apparatus, a display control apparatus, a display control method, and an electronic apparatus in which the process of switching between 2D display and 3D display is simplified.

### First Embodiment

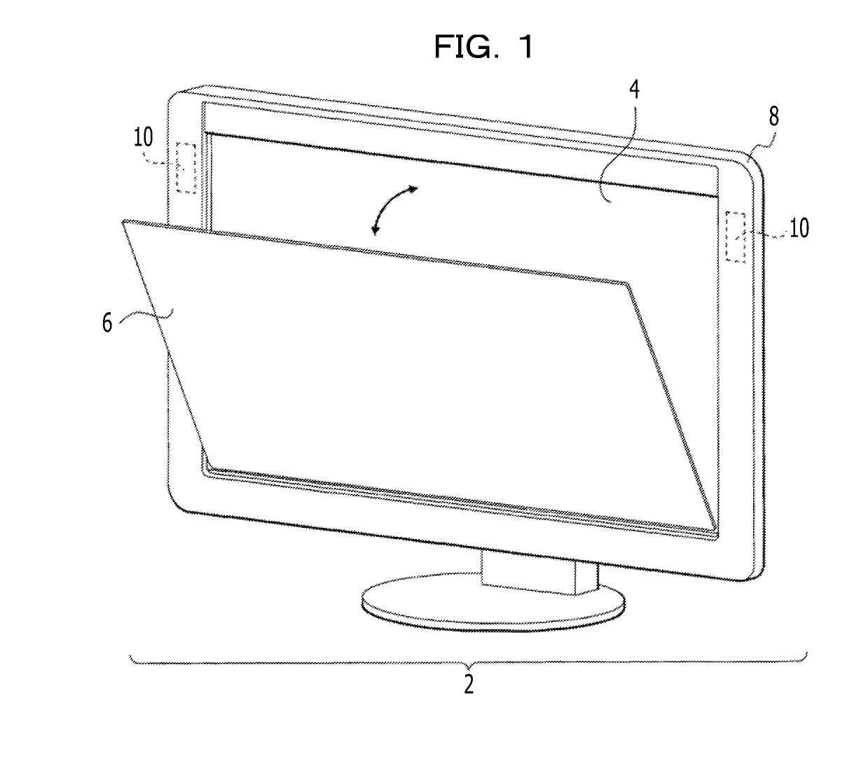

An example of the configuration of a display apparatus according to a first embodiment of the present disclosure will be described below with reference to FIG. 1. The configuration illustrated in FIG. 1 is an example only, and the disclosure is not restricted to this.

A display apparatus 2 illustrated in FIG. 1 is an example of a display apparatus, a display control apparatus, or an electronic apparatus according to an aspect of the present disclosure. A filter panel 6 is configured to be attachable to and detachable from a display unit 4, and a viewer is able to perceive images displayed on the display unit 4 two-dimensionally or three-dimensionally in accordance with whether or not the filter panel 6 is set for the display unit 4. The display apparatus 2 is, for example, a personal computer (PC) monitor or a television broadcasting display device, and includes, for example, the display unit 4, the filter panel 6, a casing 8, and attachment/detachment detectors 10.

The display unit 4 is an example of an image display device, and displays image information concerning photographs and moving pictures, for example, provided from a PC or a television receiver. Any type of display unit 4 may be used as long as it is capable to display provided 3D images, and a liquid crystal display (LCD), a plasma display panel (PDP), or another display device may be used. In order to allow a viewer to recognize 3D images through the use of the filter panel 6 configured in a planar shape, the display screen of the display unit 4 is also configured in a planar shape.

The filter panel 6 is an example of a device which is fixed to the front side of the display unit 4 and which allows a viewer to three-dimensionally perceive 3D images with the naked eyes. The filter panel 6 has a filter function to allow stereoscopic images to pass therethrough from 3D images displayed on the display unit 4. The visualization of 3D images by using the filter panel 6 is implemented by utilizing a parallax barrier system or a lenticular lens system. In this parallax barrier system, a viewer views different images with a left eye and a right eye through a film having numerous pinholes. Then, when viewing two pinholes with the left and right eyes, the viewer views different areas at the opposite side of the pinholes with the left and right eyes because of the angular difference between the left and right eyes. In those areas, two different items of information for the left eye and the right eye are separately placed, thereby allowing the viewer to recognize stereoscopic images. In the lenticular lens system, minuscule cylindrical lenses are disposed on the front side of the filter panel 6. Light from an image is refracted by the lenses to produce a parallax between the left eye and the right eye, thereby implementing stereoscopic display. Since lenses transmit images, the lenticular lens system is more advantageous than the parallax barrier system in that the luminance may be maintained.

The filter panel 6 is set to be attachable to and detachable from the display unit 4. For example, it is detached from display unit 4 when a viewer views 2D images, and is attached to the display unit 4 when the viewer views 3D images. 3D images are images processed for 3D display, and even if the viewer views 3D images displayed on the display unit 4 with the naked eyes, it is difficult (or impossible) for the viewer to three-dimensionally perceive the 3D images.

The casing 8 is an example of an outer case for the display apparatus 2 and accommodates therein the display unit 4 and the filter panel 6 which is set on the display unit 4. The casing 8 also integrates therein functional components of a provision apparatus for providing, for example, image information to be displayed on the display unit 4, or the attachment/detachment detectors 10 for monitoring the state regarding whether the filter panel 6 is attached to or detached from the display unit 4.

The attachment/detachment detectors 10 are an example of a device for detecting and monitoring the state regarding whether the filter panel 6 is attached to or detached from the front side of the display unit 4. Sensors, for example, may be disposed within the casing 8 so as to detect the contact of the filter panel 6. Upon detecting that the filter panel 6 has attached or detached from the display unit 4, the attachment/detachment detectors 10 output attachment/detachment information indicating the state of the filter panel 6 to a display control apparatus for the display apparatus 2 or to an image providing unit, such as a PC, which is externally set. Then, in accordance with the attachment/detachment information, the image providing unit, for example, starts displaying images or switches the display mode between 3D images and 2D images.

With this configuration, the filter panel 6, which allows a viewer to recognize 3D images, is attachable to and detachable from the display unit 4. Then, by monitoring the attachment/detachment state of the filter panel 6, when the filter panel 6 is attached to the display unit 4, 3D images may be viewed, and when the filter panel 6 is detached from the display unit 4, 2D images may be viewed. Additionally, 2D images or 3D images may be extracted in accordance with the attachment/detachment state of the filter panel 6, which also implements image display suitable for the display mode of the display unit 4.

### Second Embodiment

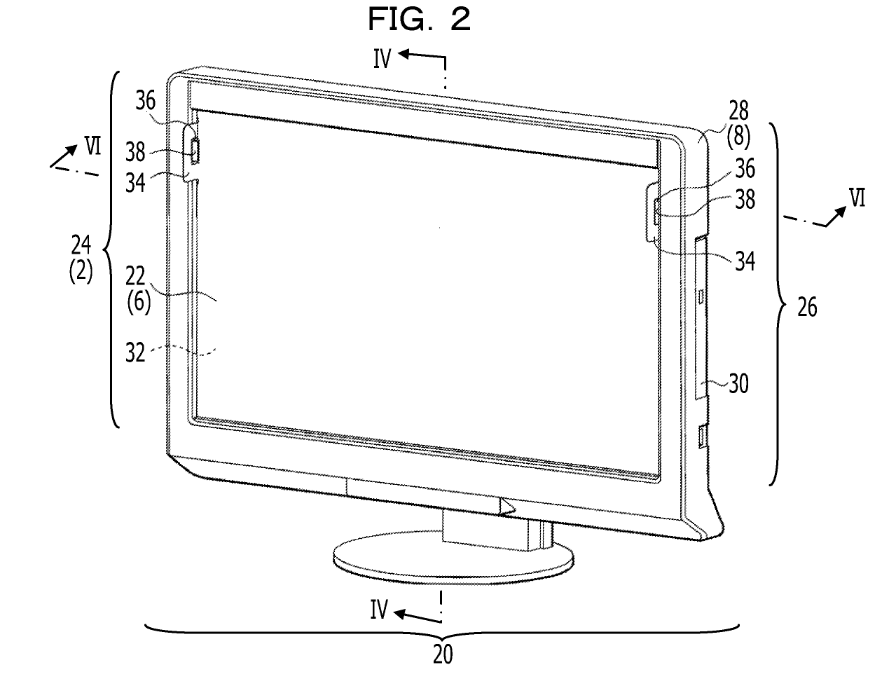

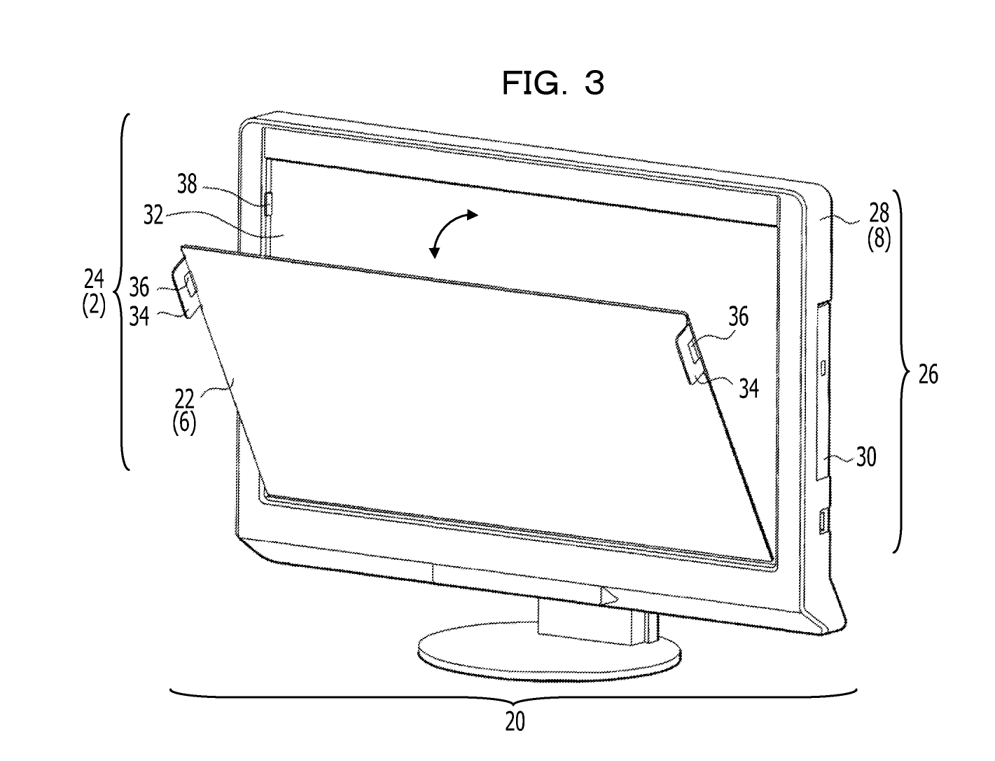

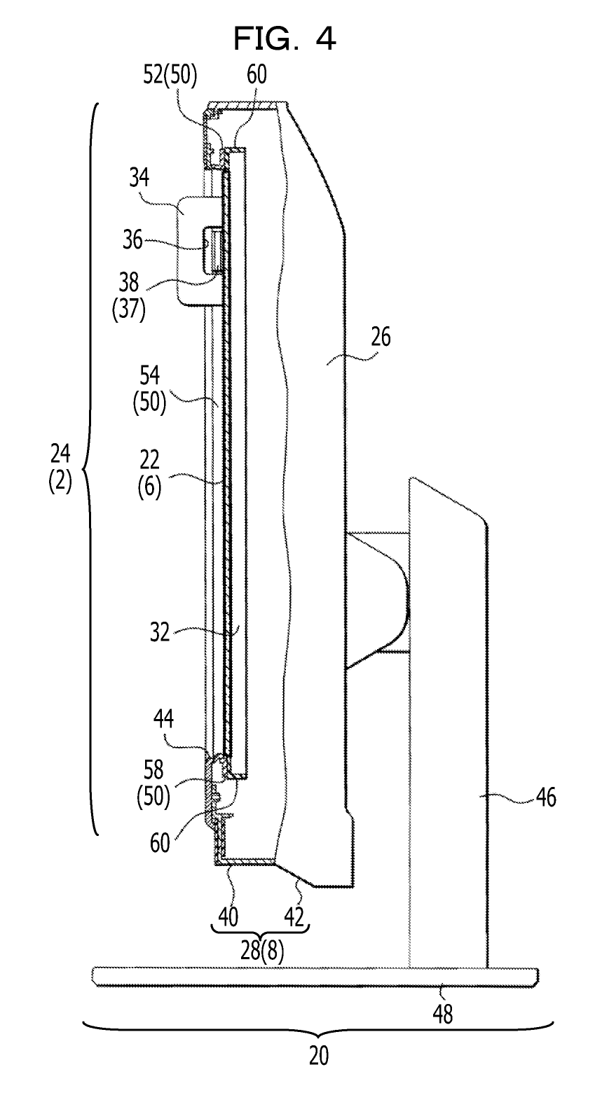

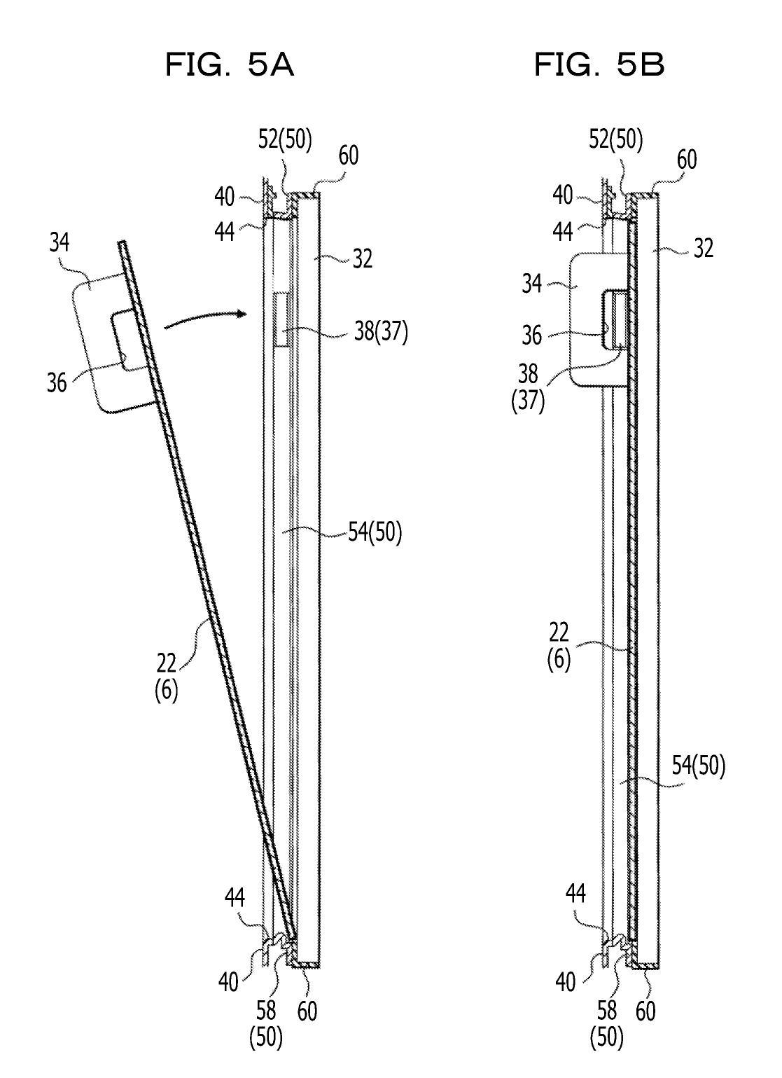

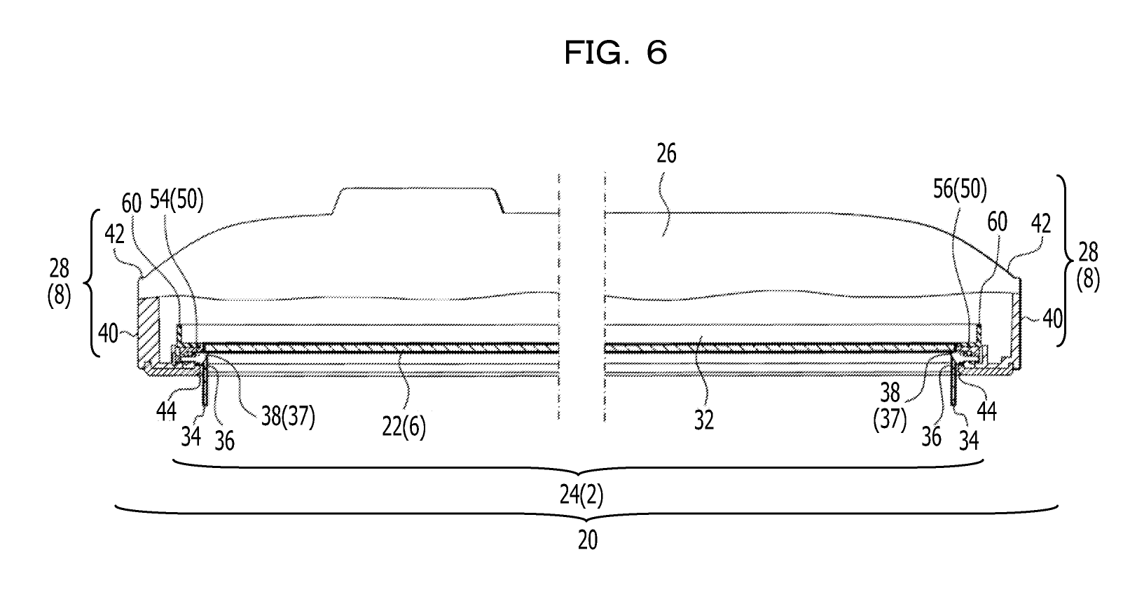

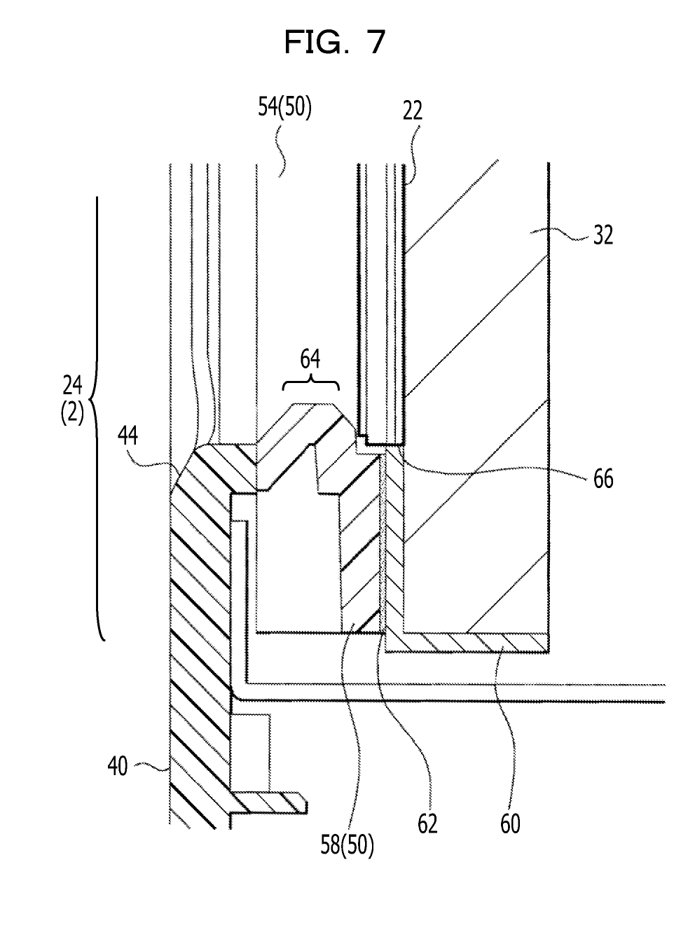

A second embodiment of the present disclosure will be described below with reference to FIGS. 2 through 7. FIG. 2 illustrates an example of the external configuration of a PC 20 according to the second embodiment. FIG. 3 illustrates an example of the attachment/detachment state of a filter panel 22. FIG. 4 is a partial view in section taken along line IV-IV of FIG. 2. FIGS. 5A and 5B are side views illustrating examples of the attachment/detachment states of the filter panel 22. FIG. 6 is a sectional view taken along line VI-VI of FIG. 2. FIG. 7 is a sectional view illustrating an example of the bottom portion of a display unit 24. The configurations illustrated in FIGS. 2 through 7 are examples only, and the disclosure is not restricted to those.

The PC 20 is an example of a display apparatus, a display control apparatus, or an electronic apparatus of an aspect of the present disclosure, and displays 3D images on the display unit 24. The filter panel 22 that allows a viewer to recognize 3D images with the naked eyes is set at the front side of the display unit 24. The PC 20 includes a casing 28 integrating therein a PC main body 26 and the display unit 24 together. The casing 28 includes, for example, the display unit 24 and a disk drive device 30.

The display unit 24 is an example of a display apparatus of an aspect of the present disclosure, and the filter panel 22 is set on the front side of an LCD unit 32. The filter panel 22 is configured, as illustrated in FIG. 3, to be attachable to and detachable from the front side of the LCD unit 32. Then, as described above, when the filter panel 22 is set on the LCD unit 32, stereoscopic images pass through the filter panel 22, as stated above, so that a user of the PC 20 may three-dimensionally perceive 3D images displayed on the display unit 24. When the filter panel 22 is detached from the LCD unit 32, the user recognizes images displayed on the display unit 24 two-dimensionally. Even if 3D images are displayed in the state in which the filter panel 22 is not attached to the LCD unit 32, the user is unable to perceive the 3D images three-dimensionally.

The filter panel 22 includes tabs 34 raised from the left and right sides of the top portion of the filter panel 22 such that the tabs 34 protrude from the front side of the display unit 24. When the filter panel 22 is attached to the display unit 24, the tabs 34 are fixed at the corresponding positions of the display unit 24 disposed within the casing 28. The tabs 34 are also an example of an attachment/detachment operating unit. The user holds the tabs 34 and attaches or detaches the filter panel 22 by pivoting the filter panel 22 to or from the LCD display unit 32 by using the bottom side of the filter panel 22 as the rotational axis. At the center of each of the tabs 34, as illustrated in FIG. 4, an opening 36 is formed. The opening 36 is an element to receive a lock 38 of a lock slider 37 which is set for the casing 28.

Within the casing 28, the PC main body 26 is disposed at the back side of the LCD unit 32, and includes, for example, a control apparatus, a storage device, a power supply source, and other function devices of the PC 20.

The disk drive device 30 is an example of an image providing unit, and reads an image program stored in a storage medium, such as a compact disk (CD) or a digital versatile disk (DVD), so as to display 3D images or 2D images on the display unit 24.

The LCD unit 32 is an example of a display unit, and is, for example, a display apparatus that may display 2D images or 3D images obtained through a storage unit of the PC 20, a storage medium, television broadcasting, or a network. The LCD unit 32 includes a liquid crystal panel, a backlight, and other control components.

The casing 28 includes, as illustrated in FIG. 4, a first casing 40 disposed at the front side of the PC 20 and a second casing 42 disposed at the back side of the PC 20. In the first casing 40, a display window 44 is formed in the first casing 40 so that the LCD unit 32 and the filter panel 22 may be disposed at the front side of the PC 20. The filter panel 22 is attached to or detached from the LCD unit 32, as stated above, through the display window 44. The second casing 42 holds the PC main body 26 disposed at the back of the display unit 24.

A support unit 46 is also provided at the back of the casing 28 to support the casing 28, and a base 48 is also provided on which the support unit 46 is placed so as to support the PC 20 from the bottom. The support unit 46 may include a hinge function of vertically changing the angle of the display unit 24.

Inside the display window 44 of the first casing 40, a frame 50 is provided to match the four corners of the LCD unit 32. The frame 50 is an example of a function of maintaining a predetermined gap between the LCD unit 32 and the first casing 40. The frame 50 forms a top frame 52, side frames 54 and 56, and a bottom frame 56 with respect to the LCD unit 32.

The height of the top frame 52 is set to match, for example, the opening of the display window 44, and the top frame 52 is in contact with a holding member 60 for holding the LCD unit 32. The holding member 60 is formed of a sheet metal to cover, for example, part of the periphery and the front side of the LCD unit 32. As illustrated in FIGS. 5A and 5B, the top frame 52 is formed not to protrude from the display window 44 so that the filter panel 22 is not brought into contact with the top frame 52 when it is attached or detached.

At positions inside the display window 44, the side frames 54 and 56 are in contact with the holding member 60 for holding the LCD unit 32. The side frames 54 and 56 each include the lock slider 37 for holding the filter panel 22 which is attached to the LCD unit 32. The lock slider 37 is an example of a slider that advances toward or recedes from the filter panel 22 from or toward the inner side of the side frame 54 or 56, and, at the forward end of the lock slider 37, the lock 38 is provided to protrude in the passage through which the filter panel 22 is attached to or detached from the LCD unit 32.

The lock 38 is an example of a panel holding unit which is inserted into the opening 36 of the filter panel 22, as illustrated in FIG. 6, so as to support the filter panel 22. The lock 38 is disposed, as illustrated in FIG. 5A, apart from the LCD unit 32 with a spacing which corresponds to the thickness of the filter panel 22. With this arrangement, the filter panel 22 is disposed, as illustrated in FIG. 5B, in parallel with the LCD unit 32, so that the amount of light passing through a 3D image displayed on the LCD unit 32 is not reduced, thereby implementing correct 3D image display.

The lock sliders 37 and the tabs 34 of the filter panel 22 are disposed at the upper portions of the side surfaces of the display window 44 so that the filter panel 22 may be held at a high position. The attachment/detachment of the filter panel 22 is performed, as illustrated in FIG. 5A, by setting the bottom side of the filter panel 22 first, and then, by pivoting the filter panel 22 about the bottom side, thereby facilitating the operation for setting the filter panel 22, which is large and heavy. Additionally, as illustrated in FIG. 5B, the lock 38 holds the filter panel 22 at a position separate from the bottom side of the filter panel 22, which is the pivoting point. Thus, the holding power for stopping the filter panel 22 from falling down from the LCD unit 32 may be decreased.

The bottom frame 58 is set, as illustrated in FIG. 7, between the bottom portion of the first casing 40 and the bottom portion of the holding member 60 disposed at the bottom side of the LCD unit 32. The bottom frame 58 and the holding member 60 are fixed to each other with, for example, an adhesive layer 62, such as double-faced adhesive tape. Additionally, a projection 64, which projects upward, is formed on the bottom frame 58 at a position corresponding to the front side of the filter panel 22 which is attached to the LCD unit 32. The projection 64 projects farther upward than the opening of the display window 44 of the first casing 40, and stops the filter panel 22 which is attached to the LCD unit 32 from shifting in parallel with the display window 44.

The holding member 60 for holding the LCD unit 32 also includes a mount 66 for placing the filter panel 22 thereon at the front side of the LCD unit 32. The mount 66 is set to be in contact with the bottom of the filter panel 22 at a position higher than the contact portion between the holding member 60 and the bottom frame 58 and lower than the projection 64 of the bottom frame 58. That is, the height of the mount 66 is set so that the bottom of the filter panel 22 is not in contact with the bottom frame 58. The holding member 60 is in contact with the LCD unit 32 without any gap or with a slight gap, and thus, by mounting the filter panel 22 on the mount 66, the parallelism between the LCD unit 32 and the filter panel 22 may be maintained. Additionally, the mount 66 is provided at a position lower than the projection 64. Accordingly, when attaching the filter panel 22, as stated above, the user first places the bottom side of the filter panel 22 and then pivots the top side of the filter panel 22, thereby making it possible to place the filter panel 22 in parallel with the LCD unit 32.

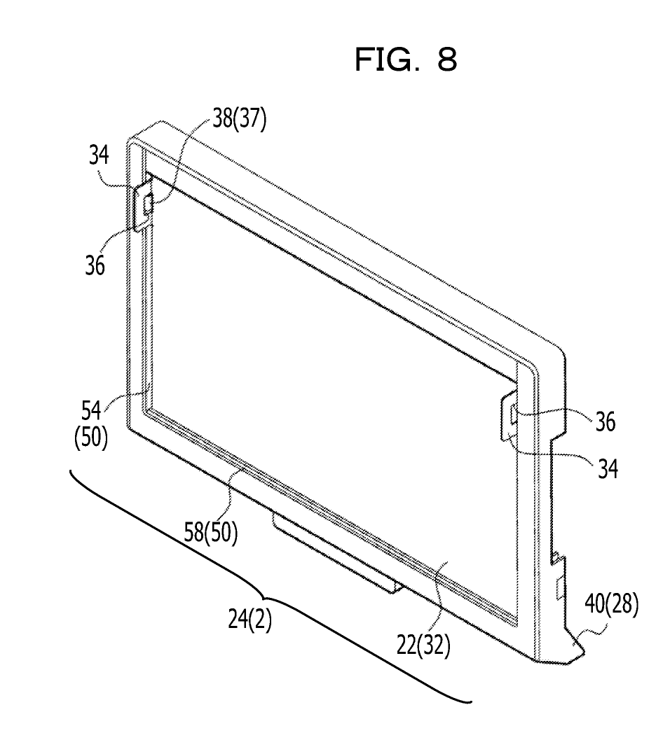

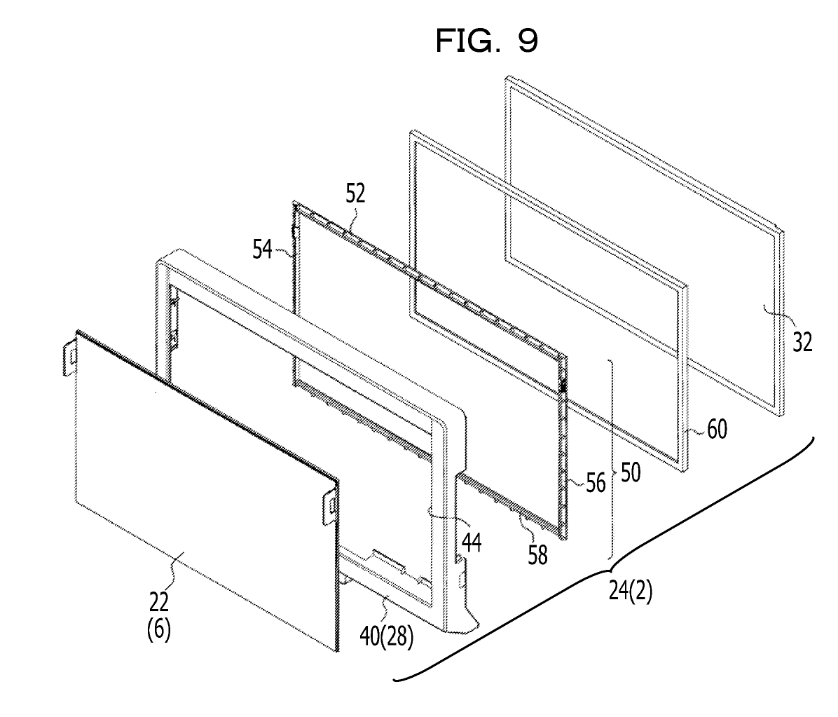

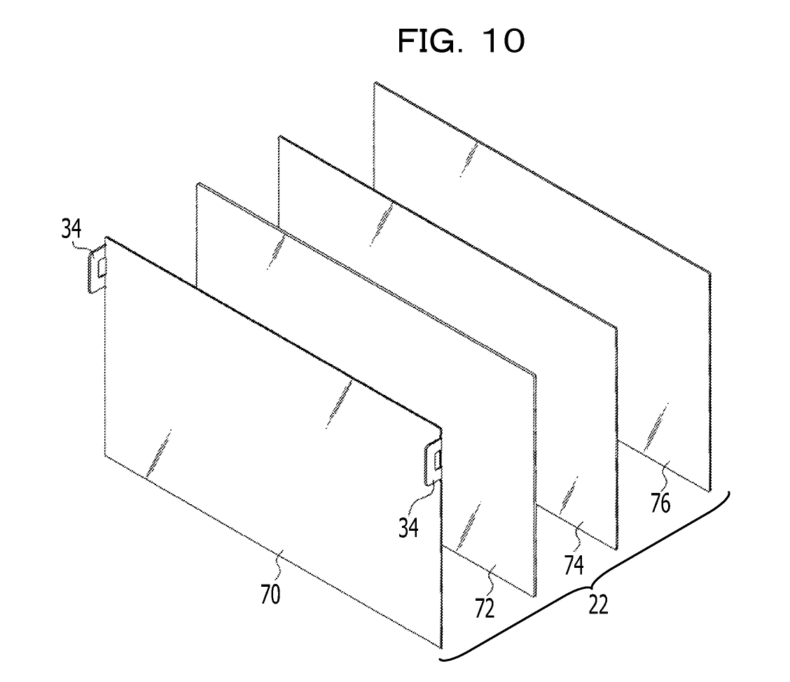

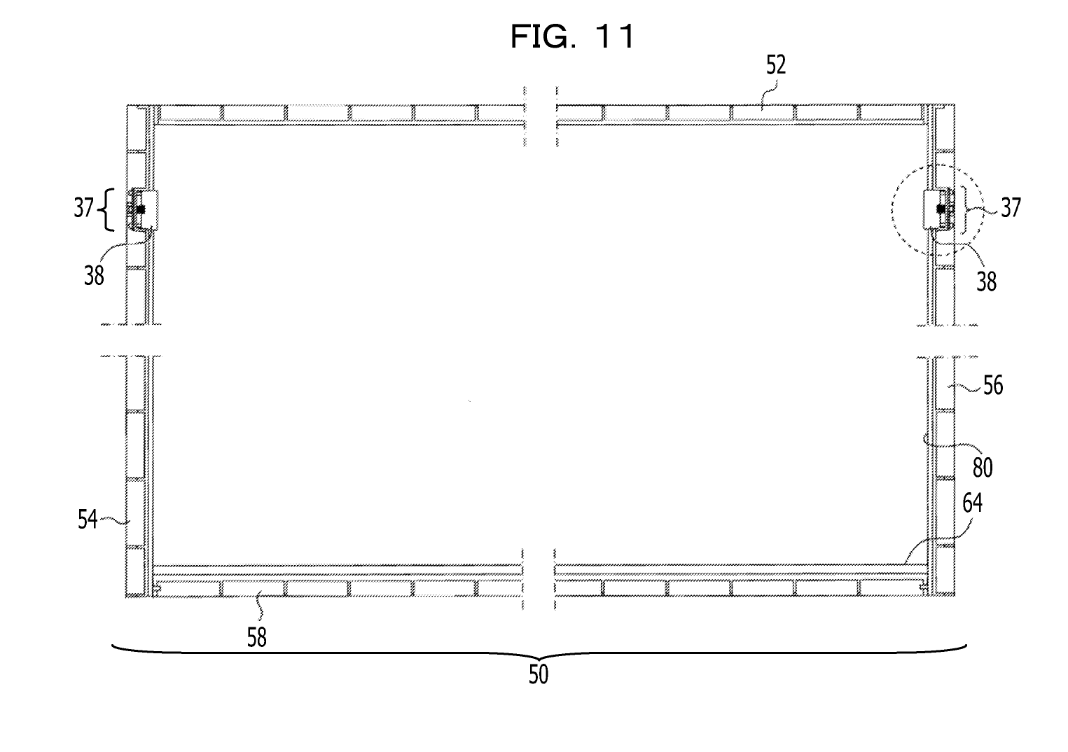

An example of the configuration of the display unit 24 will be described below with reference to FIGS. 8 through 11. FIG. 8 illustrates an example of the configuration of the display unit 24 and the surrounding components. FIG. 9 is an exploded view illustrating an example of the configuration of the display unit 24 and the surrounding components. FIG. 10 illustrates an example of the configuration of the filter panel 22. FIG. 11 illustrates an example of the configuration of the frame 50. The configurations illustrated in FIGS. 8 through 11 are examples only, and the present disclosure is not restricted to those.

The display unit 24 illustrated in FIG. 8 is an example of a display function of the PC 20, and is disposed at the front side of the PC 20. As stated above, the attachable and detachable filter panel 22 is set on the front side of the LCD unit 32, thereby implementing 3D image display.

In the display unit 24, as illustrated in FIG. 9, for example, the LCD unit 32 is set inside the first casing 40 with the frame 50 and the holding member 60 therebetween so that the display surface of the LCD unit 32 faces the display window 44. Then, the attachable and detachable filter panel 22 is set on the LCD unit 32 from the front side of the display window 44 of the first casing 40.

The filter panel 22 illustrated in FIG. 10 is formed by stacking a plurality of panel components, and includes a panel 70 provided with tabs 34, a reinforcing panel 72, a 3D panel 74, and a film 76. The tab panel 70 is made of a transparent resin or a light transmitting resin and is disposed at the front side of the display unit 24. As stated above, the tabs 34 are provided on the side surfaces of the top portion of the tab panel 70. The user of the PC 20 holds the tabs 34 so as to attach or detach the filter panel 22 to or from the display unit 24.

The reinforcing panel 72 is an example of a function of protecting the 3D panel 74 in case that the user touches the filter panel 22 when attaching or detaching the filter panel 22. The reinforcing panel 72 also inhibits the filter panel 22 from being deformed due to, for example, the application of pressure, and maintains the parallelism of the 3D panel 74.

The 3D panel 74 is an example of a filter panel that allows stereoscopic images to pass therethrough from the 3D images displayed on the LCD unit 32, and is constituted of a lenticular lens unit or a lens utilizing the parallax barrier system.

The film 76 is part of the filter panel 22 and is disposed so as to face the LCD unit 32 to protect the 3D panel 74.

The stacking configuration of the filter panel 22 illustrated in FIG. 10 is an example only. The order in which the tab panel 70, the reinforcing panel 72, and the film 76 are stacked on the 3D panel 74 may be changed, or the film 76 may be omitted. The stacking configuration of the filter panel 22 may be changed in accordance with the setting of the quantity of light to pass through the filter panel 22, or the designing of the weight or the thickness of the filter panel 22.

The frame 50 illustrated in FIG. 11 covers the periphery of the display screen of the LCD unit 32 with the top frame 52, the side frames 54 and 56, and the bottom frame 58 so that the display screen of the LCD unit 32 may be seen through an opening 80 formed in the frame 50. As stated above, the side frames 54 and 56 each include the lock slider 37, and the lock 38, which is fit into the opening 36 formed in the tab 34 of the filter panel 22 and locks the filter panel 22, is formed at the forward end of the lock slider 37. The lock slider 37 holds the filter panel 22 and also serves as a detector for detecting the attachment/detachment of the filter panel 22.

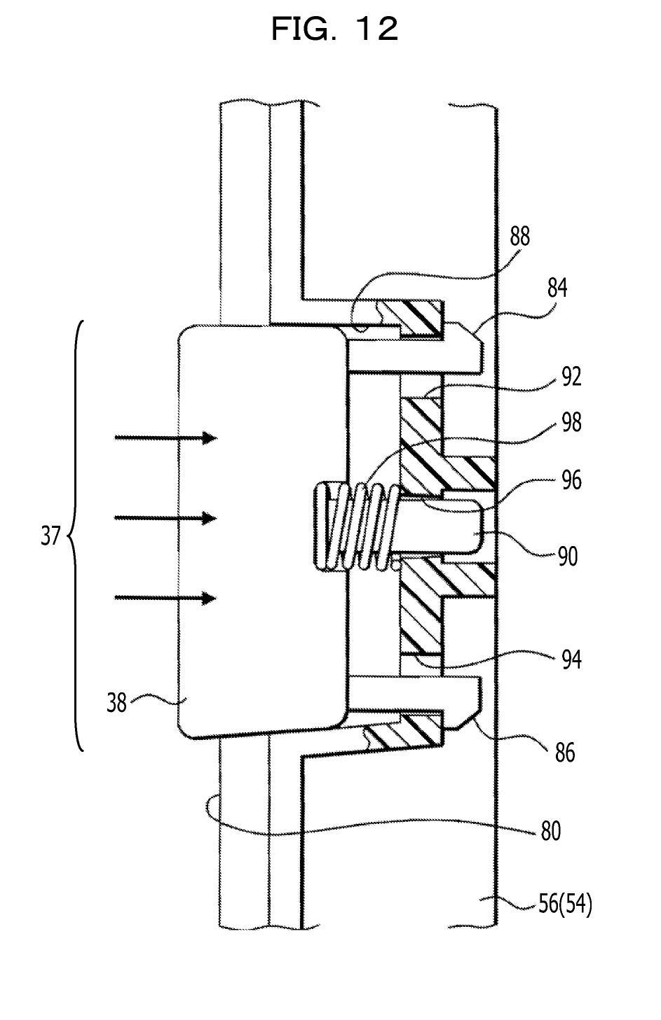

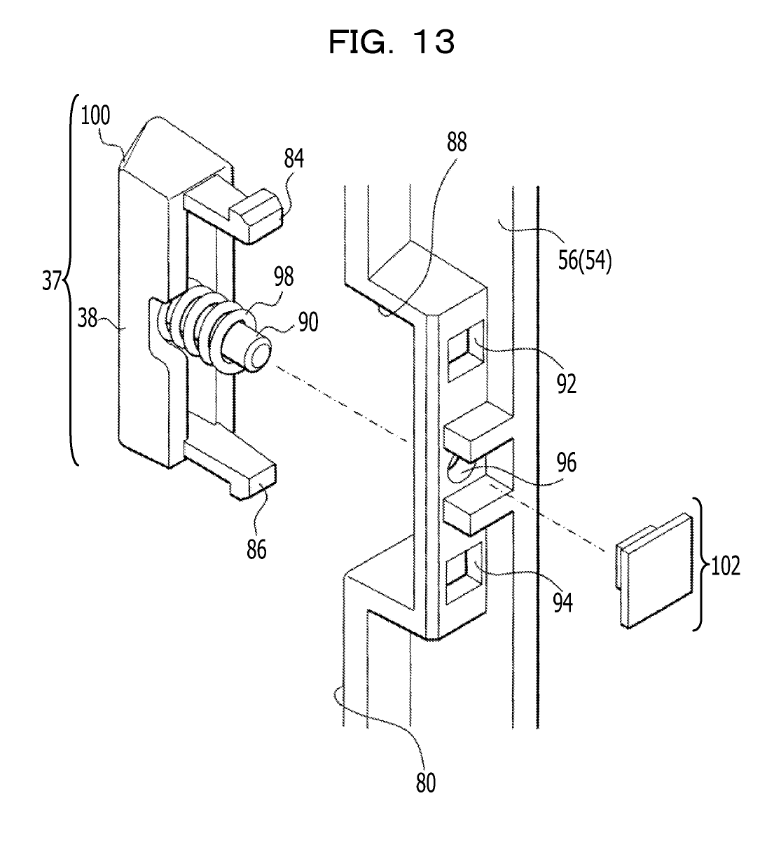

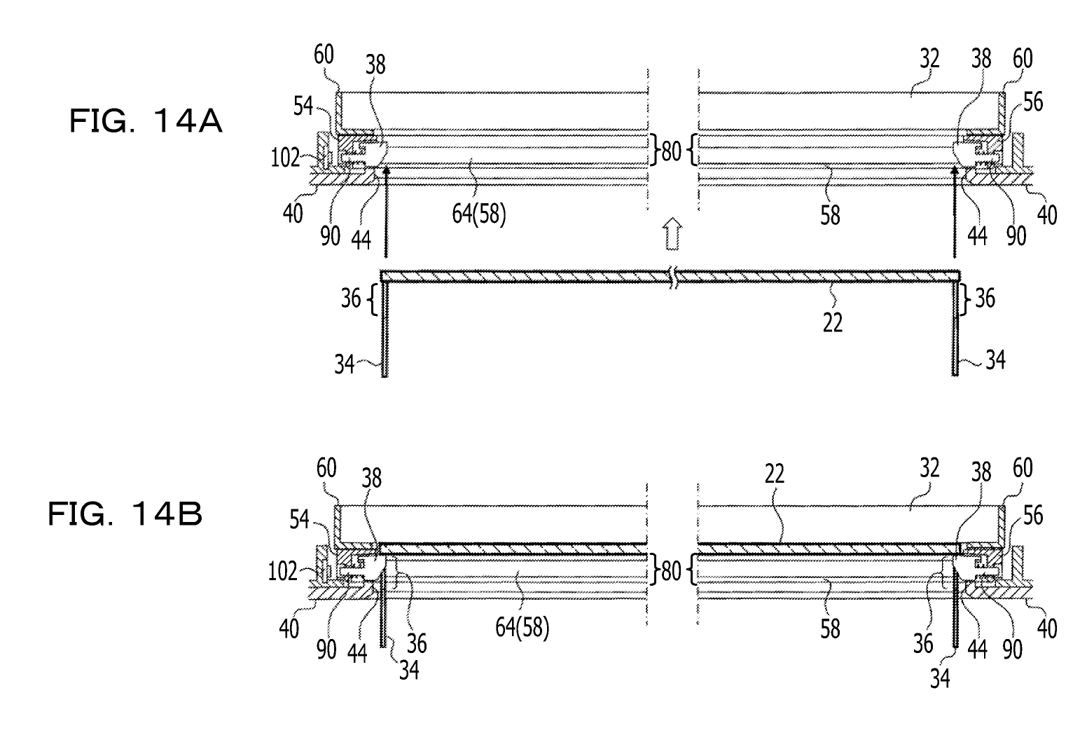

The functional configuration of the lock slider 37 will be described below with reference to FIGS. 12 through 14. FIG. 12 illustrates an example of the configuration of the lock slider 37. FIG. 13 illustrates an example of the configurations of the lock slider 37 and a switch 102. FIGS. 14A and 14B illustrate an example of the state in which the filter panel 22 is being held against the display unit 24. The configurations illustrated in FIGS. 12 through 14B are examples only, and the present disclosure is not restricted to those.

The lock slider 37 may retain the tab 34 of the filter panel 22 by allowing the lock 38 formed at the forward end of the lock slider 37 to project toward the opening 80 of the frame 50, as illustrated in FIG. 12. The lock slider 37 moves in the widthwise direction of the side frame 54 or 56 when attaching or detaching the filter panel 22. The lock slider 37 includes retaining claws 84 and 86 and a slide pin 90. The retaining claws 84 and 86 retain the filter panel 22 toward the side frame 54 or 56 so as to restrict the movement of the filter panel 22 toward the opening 80. The slide pin 90 guides the advancement and retreat of the lock slider 37.

The lock slider 37 is disposed such that it is slidable to a slide frame 88 provided in the side frame 54 or 56. The retaining claws 84 and 86 are fit into retaining holes 92 and 94, respectively, formed in the slide frame 88. The slide pin 90 is caused to pass through a guide hole 96 formed in the slide frame 88 through the use of a spring 98.

The lock 38 includes, as illustrated in FIG. 13, a tilt surface 100 which tilts with respect to the opening 80 and from the front side to the back side of the display surface. When the lock slider 37 slides toward the slide frame 88, the retaining claws 84 and 86 are securely fit into the retaining holes 92 and 94, respectively. Similarly, the slide pin 90 is securely fit into the guide hole 96, and at the same time, the spring 98 is compressed in the sliding direction.

The slide pin 90 guides the lock slider 37 toward the slide frame 88. The slide pin 90 is also an example of a switching function of bringing the lock slider 37 into contact with the switch 102 illustrated in FIG. 13 so as to change ON/OFF of the switch 102. The slide pin 90 and the switch 102 form an attachment/detachment detector for detecting the attachment/detachment of the filter panel 22. The slide pin 90 is disposed at the back side of the lock slider 37 or is integrally formed with the lock slider 37, and the spring 98 is wound around the slide pin 90.

The spring 98 is an example of an urging function of urging the lock slider 37, and is fixed at one end to the back side of the lock 38 and is at the other end in contact with part of the slide frame 88. When the filter panel 22 is attached or detached, the lock 38 is pressed, and then, the spring 98 contracts within the slide frame 88 so as to urge its restoring force to the lock 38. Thus, part of the lock 38 is caused to project toward the frame 50.

The urging function of urging the lock slider 37 is not restricted to a spring, and may be any type of elastic member, such as rubber, as long as it produces a restoring force.

The switch 102 is an example of an attachment/detachment detector for the attachment/detachment of the filter panel 22, and contacts the slide pin 90 projecting from the guide hole 96 when the lock slider 37 slides. Because of the contact of the switch 102 to the slide pin 90, ON/OFF of the switch 102 is changed to allow the switch 102 to detect that the filter panel 22 has been attached or detached. A switching signal from the switch 102 is sent to the controller of the PC 20, for example, and when the filter panel 22 is attached, the controller shifts the image display of the LCD unit 32 to the 3D image display mode.

The configuration of the lock slider 37 illustrated in FIG. 13 is the lock slider 37 formed on the side frame 56. The lock slider 37 formed on the side frame 54 may be similarly configured. The switch 102 for detecting the attachment/detachment of the filter panel 22 may be set on one of or each of the side frames 54 and 56.

The state in which the filter panel 22 is being attached to the display unit 24 is illustrated in FIGS. 14A and 14B. Within the display window 44 of the first casing 40, as illustrated in FIG. 14A, the locks 38 project from the side frames 54 and 56 and are positioned to stop the filter panel 22 in the direction in which the filter panel 22 is attached to the display unit 24, as stated above. Then, the locks 38 are depressed to slide so as to allow the filter panel 22 to fit into the opening 80 formed in the frame 50, and then, the depression of the locks 38 is released. With this operation, as illustrated in FIG. 14B, the locks 38 are fit into the openings 36 of the filter panel 22 so as to bring one end of each of the lock sliders 37 into contact with the filter panel 22, thereby retaining the filter panel 22.

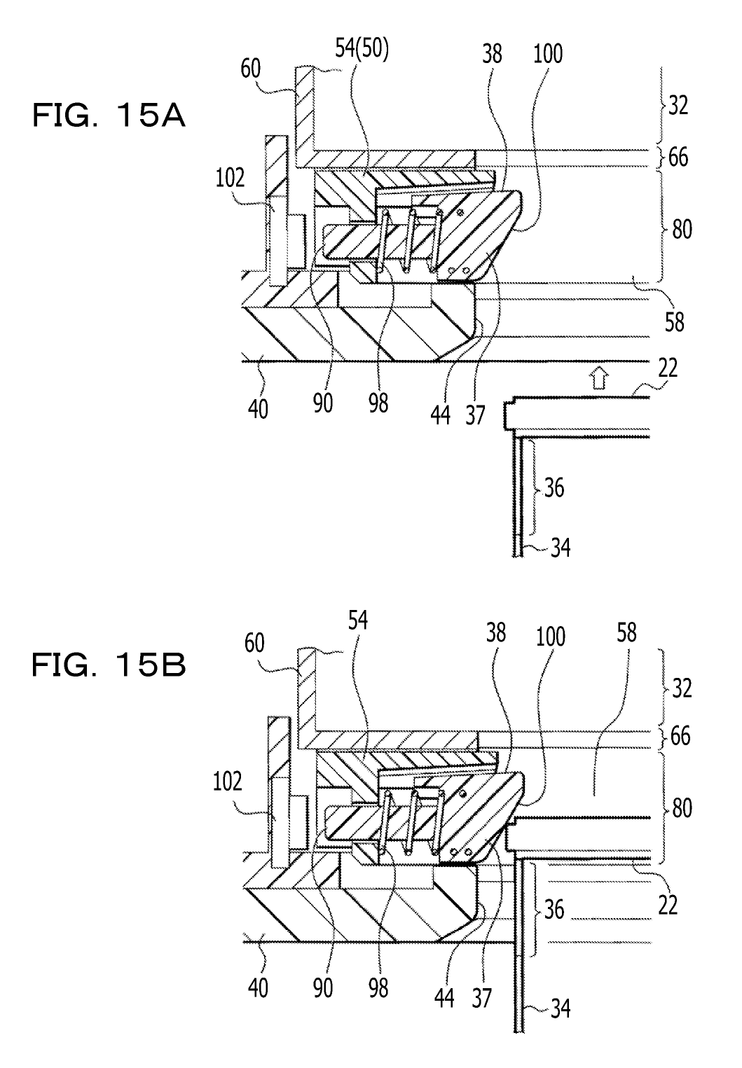

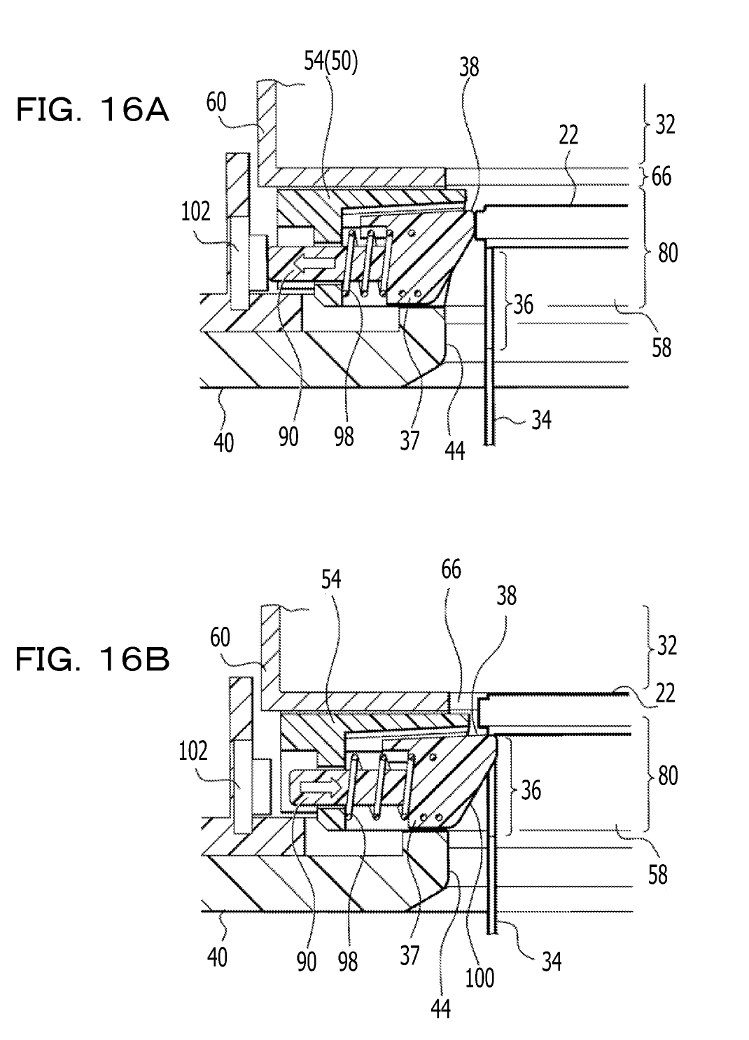

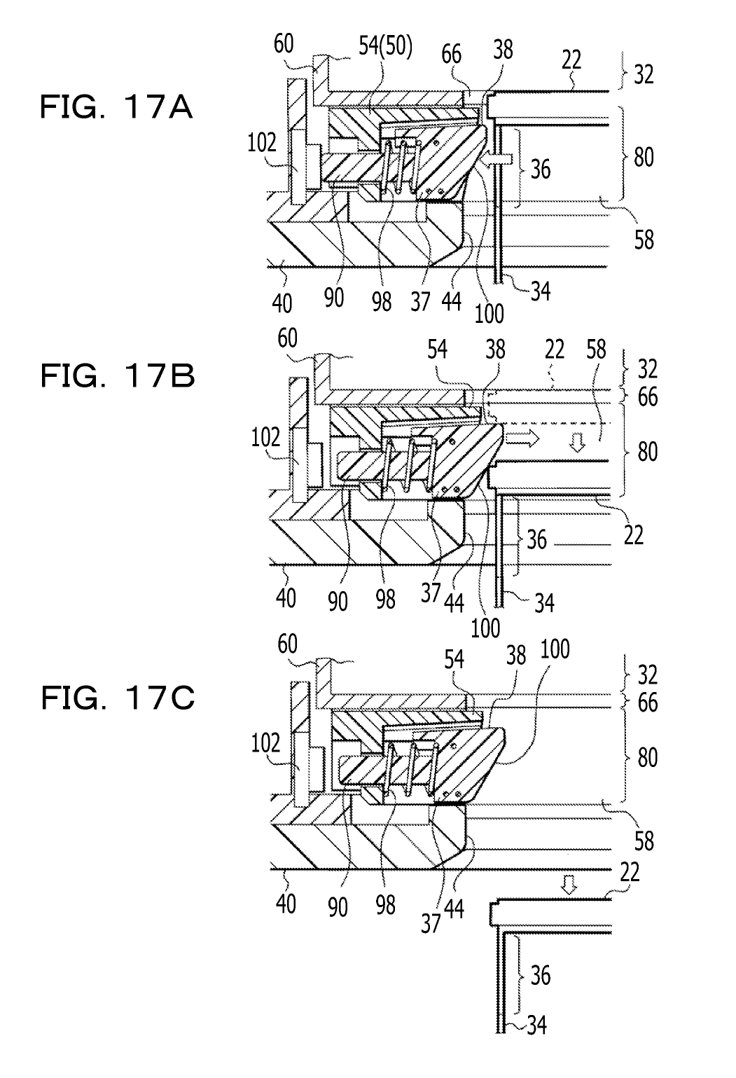

The attachment/detachment operations of the filter panel 22 will be described below with reference to FIGS. 15A through 17C. FIGS. 15A through 16B illustrate an example of the sliding operation of the lock slider 37 when the filter panel 22 is being attached. FIGS. 17A through 17C illustrate an example the sliding operation of the lock slider 37 when the filter panel 22 is detached.

Before the filter unit 22 is attached, as illustrated in FIG. 15A, the tilt surface 100 formed on the lock 38 projects toward the display window 44. In this state, the spring 98 of the lock slider 37 is stretched to the maximum, and the slide pin 90 is separate from the switch 102.

The filter panel 22 is moved into the display window 44, and as stated above, the bottom portion of the filter panel 22 is placed on the mount 66 of the holding member 60. Then, the top portion of the filter panel 22 is pivoted toward the LCD unit 32 by using the bottom portion of the filter panel 22 as the rotational axis so as to cause the back side of the filter panel 22 to contact the tilt surface 100 of the lock 38, as illustrated in FIG. 15B. At this time, the lock slider 37 has not started to slide toward the outer periphery of the side frame 54 or 56.

When the user depresses the tab 34 into the display unit 24, the lock slider 37 receives the depression force by the tilt surface 100, and starts to slide toward the outer periphery of the side frame 54 or 56 by resisting the elastic force of the spring 98. The filter panel 22 slides on the tilt surface 100 while being inserted, which also causes the lock slider 37 to slide. Then, when the filter panel 22 is in contact with the end of the lock 38, as illustrated in FIG. 16A, the lock slider 37 has moved to the maximum, and at this time, the slide pin 90 presses the switch 102 and the PC 20 detects that the filter panel 22 has been attached.

Then, when the filter panel 22 is further inserted to closely contact the LCD unit 32, as illustrated in FIG. 16B, the lock slider 37, which has been released from the pressing force of the filter panel 22, is moved to the initial position due to the restoring force of the spring 98. That is, the lock slider 37 is moved until the tilt surface 100 of the lock 38 projects toward the opening 80. Because of this movement of the lock slider 37, the forward end of the tilt surface 100 is fit into the opening 36 of the tab 34 so that the lock 38 may retain the filter panel 22.

The detachment of the filter panel 22 is performed as follows. The lock 38 is depressed, as illustrated in FIG. 17A to allow the lock slider 37 to slide toward the side frame 54 or 56, thereby releasing the lock 38 fit in the opening 36 of the tab 34. The user may perform this releasing operation of the lock 38 by holding the tab 34 and pressing the lock 38 with a finger. Because of the depression of the lock 38, the lock slider 37 starts to slide to allow the slide pin 90 to contact the switch 102. The switch 102 then detects the contact of the slide pin 90 and sends information indicating the depression of the lock 38 to a display controller or an image providing device, such as a PC.

The user pivots the filter panel 22 to remove it from the LCD unit 32 while depressing the lock 38, and then, as illustrated in FIG. 17B, the filter panel 22 is removed while allowing part of the filter panel 22 to slide against the tilt surface 100 of the lock 38. In accordance with the removal of the filter panel 22, the load on the lock slider 37 is decreased to release the contact between the filter panel 22 and the lock 38. The lock slider 37 then returns to the initial position such that the lock 38 projects from the side panel portion 54 or 56 as illustrated in FIG. 7C.

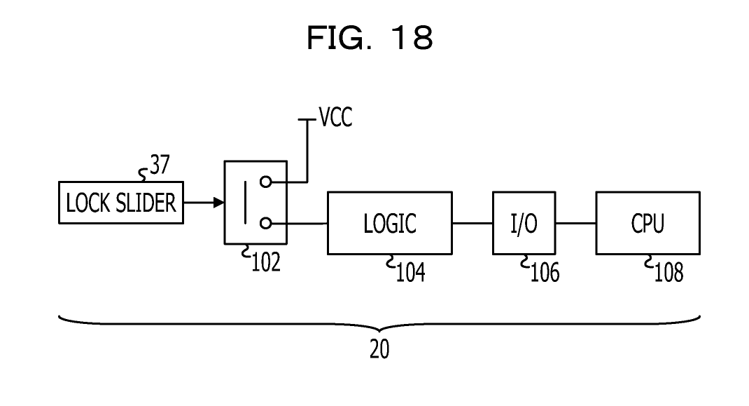

An example of the functional configuration of the attachment/detachment detector will be described below with reference to FIG. 18.

The PC 20 detects that the filter panel 22 has attached to or detached from the display unit 24, and then shifts to, for example, the 3D display mode for displaying 3D images. As the attachment/detachment detector for the filter panel 22, the lock slider 37, which slides in accordance with the attachment/detachment operation of the filter panel 22, is used, as stated above. The lock slider 37 advances or recedes so as to contact the switch 102. Upon being in contact with the lock slider 37, the switch 102 is pressed so as to be changed to ON or OFF.

Every time the switch 102 is pressed, it is electrically connected to or disconnected from the power supply source (power ON or OFF state). The controller of the PC 20 recognizes this switching operation between the ON and OFF states as a switching signal obtained by detecting that the filter panel 22 has been attached or detached. The controller of the PC 20 includes, for example, a logic circuit 104, an input/output (I/O) 106, and a central processing unit (CPU) 108.

The logic circuit 104 is an example of a matching device, and forms a functional circuit for performing chattering elimination, logical consistency, etc., for a switching signal output from the switch 102.

The I/O 106 is an example of an interface that inputs an attachment/detachment detection signal into the controller. The I/O 106 identifies the attachment/detachment detection signal output from the switch 102, and then triggers an operation control program of the PC 20 by using this signal as an event on the basis of the behavior indicated in the attachment/detachment detection signal. The I/O 106 may be constituted by a general purpose I/O (GPIO) of a chip set forming the controller.

The CPU 108 is an example of an arithmetic unit, and controls the operation of the PC 20 by the execution of the control program. The CPU 108 performs display control for switching the display mode of images to be displayed on the display unit 24 to the 2D display mode or the 3D display mode, on the basis of the attachment/detachment detection signal for the filter panel 22.

The switch 102 is not restricted to a type which detects the attachment/detachment of the filter panel 22 by the depression of the lock slider 37. Alternatively, a magnetic sensor for detecting the attachment/detachment of the filter panel 22 by the approach of the filter panel 22 may be used.

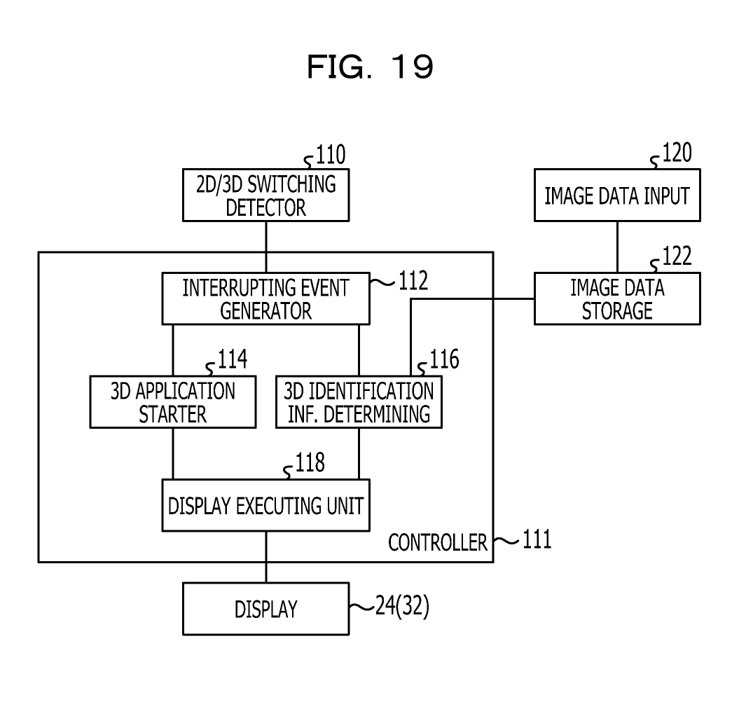

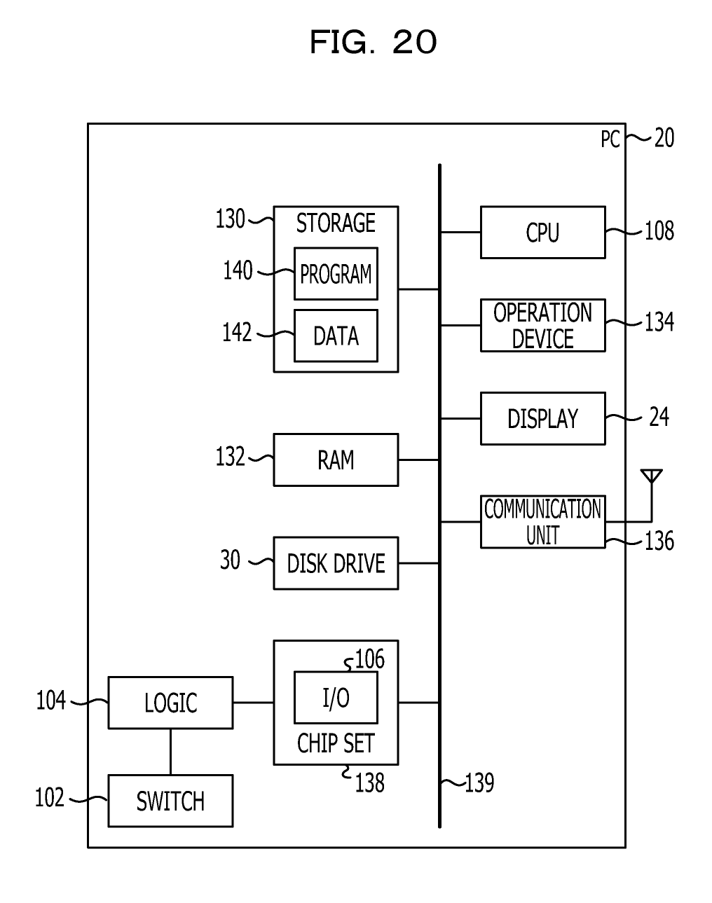

An example of the configuration of the display control function of the PC 20 and an example of the hardware configuration of the PC 20 will be described below with reference to FIGS. 19 and 20, respectively.

The PC 20 performs display control in accordance with the attachment/detachment of the filter panel 22. For example, as stated above, when the filter panel 22, which allows stereoscopic images to pass therethrough, is attached to the front side of the LCD unit 32, the PC 20 is operable to extract 3D images and display them. To implement this display control, the PC 20 includes a 2D/3D switching detector 110, a controller 111, the display unit 24, an image data input unit 120, and an image data storage 122. The controller 111 includes an interrupt event generator 112, a 3D application starter 114, a 3D identification information determining unit 116, and a display executing unit 118.

The 2D/3D switching detector 110 is an example of a function of monitoring whether or not the display unit 24 is in the state to display 3D images, and includes, for example, the switch 102. The 2D/3D switching detector 110 detects changing of the switch 102 because of the attachment/detachment operation of the filter panel 22 to/from the LCD unit 32 so as to detect whether 2D images or 3D images are to be displayed.

The controller 111 is an example of a function of switching the screen display of the display unit 24 to the 2D image display mode or the 3D image display mode in accordance with the attachment/detachment state of the filter panel 22. When the filter panel 22 is attached, the controller 111 extracts 3D image information from the image data storage 122, which serves as an image providing device, and instructs the display unit 24 to perform display processing for 3D images. When the filter panel 22 is not set on the display unit 24, the controller 111 extracts image information without 3D image information from the image data storage 122 and instructs the display unit 24 to display the extracted image information.

The interrupt event generator 112 is an example of a function of performing display interrupt control in accordance with a detection signal output from the 2D/3D switching detector 110. When the filter panel 22 is attached to the LCD display unit 32, the interrupt event generator 112 instructs the controller of the PC 20 to shift to the 3D display mode in order to extract and display 3D images. In contrast, when the filter panel 22 is detached from the LCD display unit 32, the interrupt event generator 112 instructs the controller of the PC 20 to shift to the 2D display mode in accordance with a detection signal output from the 2D/3D switching detector 110.

The 3D application starter 114 is an example of a display controller for displaying 3D images. The 3D application starter 114 reads and checks a defined 3D image format, starts an image playback program, performs 3D display setting processing, etc.

The 3D identification information determining unit 116 is an example of a function of determining whether image data stored in the image data storage 122 contains 3D images and of extracting 3D images. The 3D identification information determining unit 116 determines, for example, whether identification information contained in image information includes information indicating 3D images.

The display executing unit 118 is an example of a function of displaying extracted 3D image information on the display unit 24. The display executing unit 118 plays back 3D images in accordance with the format set by the 3D application starter 114.

The image data input unit 120 is an example of a function of obtaining image information from, for example, a storage medium.

The image data storage 122 is an example of a function of storing 2D image data or 3D image data that may be executed by the PC 20.

In the PC 20 illustrated in FIG. 20, the CPU 108, a storage 130, a random access memory (RAM) 132, an operation input device 134, and a communication unit 136, for example, are connected to one another through the use of a chip set 138 and a bus 139. The PC 20 performs display control processing regarding whether 2D images or 3D images are to be displayed on the display unit 24.

The storage 130 is an example of a function of storing image information, control programs, etc., and stores therein an operating system (OS) for controlling the operation of the PC 20, an image execution program, 3D execution format data, and other control programs. The storage 130 includes, for example, a program storage section 140 and a data storage section 142.

The program storage section 140 is an example of a function of storing an operation control program, etc., for the PC 20, and is constituted of, for example, a read only memory (ROM). The program storage section 140 stores an OS, an image execution program, a 2D/3D switching program, etc., as stated above. When image processing is executed, those programs are read from the program storage section 140.

The data storage section 142 is an example of a function of storing image information, etc., and is constituted of a ROM or a flash memory. The data storage section 142 serves as the above-described image data storage 122.

The program storage section 140 and the data storage section 142 may be each constituted of an electrically erasable and programmable read only memory (EEPROM).

The above-described image information, image execution program, and data, such as the 3D execution format data, are not restricted to those stored in the program storage section 140 or the data storage section 142. For example, programs and data stored in a computer-readable recording medium, such as a magnetic disk, a flexible disk, an optical disc, or a magneto-optical disk, may be used. Alternatively, programs and data may be read from a server or a database provided on a network.

The RAM 132 forms a work area for executing the operation control program, etc. The CPU 108 executes the control program so as to serve as, for example, the 2D/3D switching detector 110, the interrupt event generator 112, the 3D application starter 114, the 3D identification information determining unit 116, and the display executing unit 118. The CPU 108 also performs operation control for the display unit 24.

The operation input device 134 is an example of a user interface for the PC 20, and is constituted of, for example, a keyboard and a mouse. When image information that may be displayed on the display unit 24 is extracted, the operation input device 134 selects, among the image information, image information that the user wishes to view, and inputs the selected image information.

The display unit 24 displays images that have been executed, and may also display a list of image information extracted from the data storage section 142.

The communication unit 136 is an example of a function of connecting to an external network environment, such as the Internet, by means of wired or wireless communication, and may receive image information or an image execution program from another PC or server.

The chip set 138 includes a control function for the storage 130, the display unit 24, etc., and is a circuit device for executing processing in cooperation with the CPU 108. The above-described I/O 106 is contained in the chip set 138.

With this configuration, on the basis of information indicating the switching operation of the switch 102 input from the I/O 106, the PC 20 identifies such information as attachment/detachment detection information of the filter panel 22, and performs display control including 2D/3D switching control.

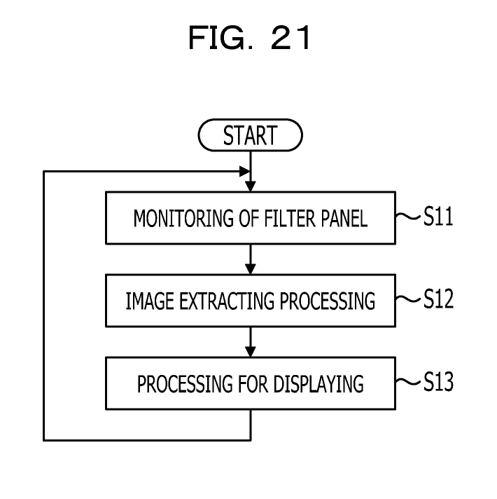

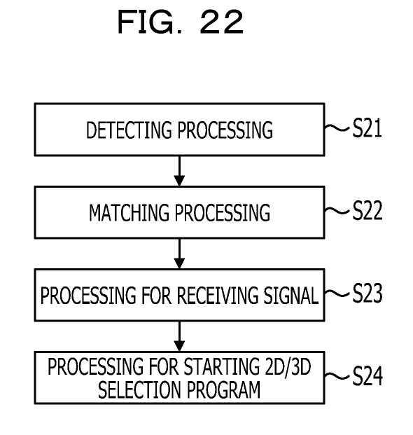

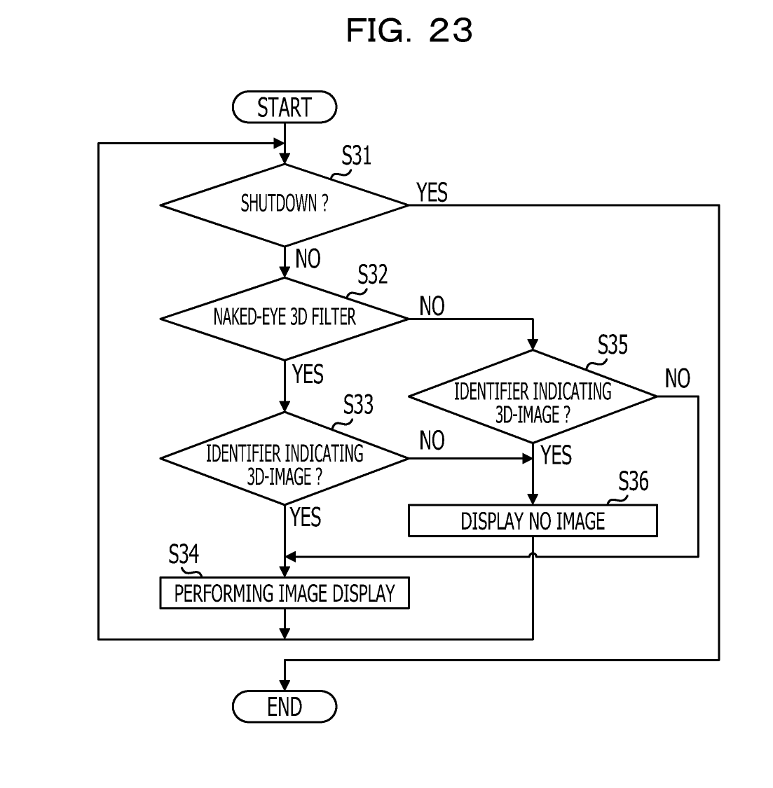

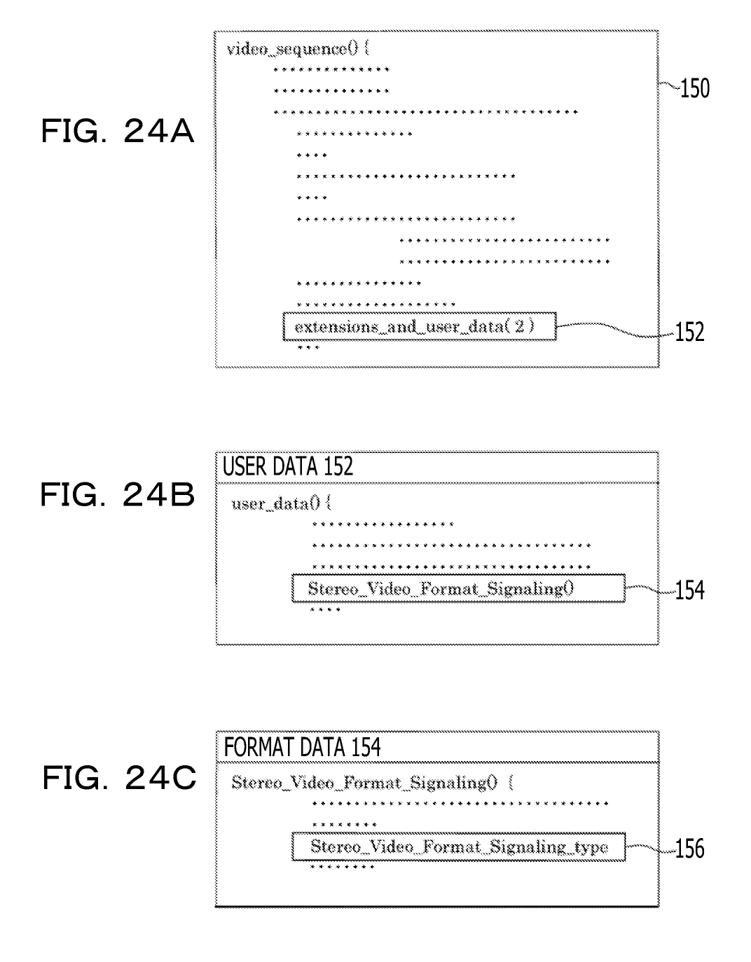

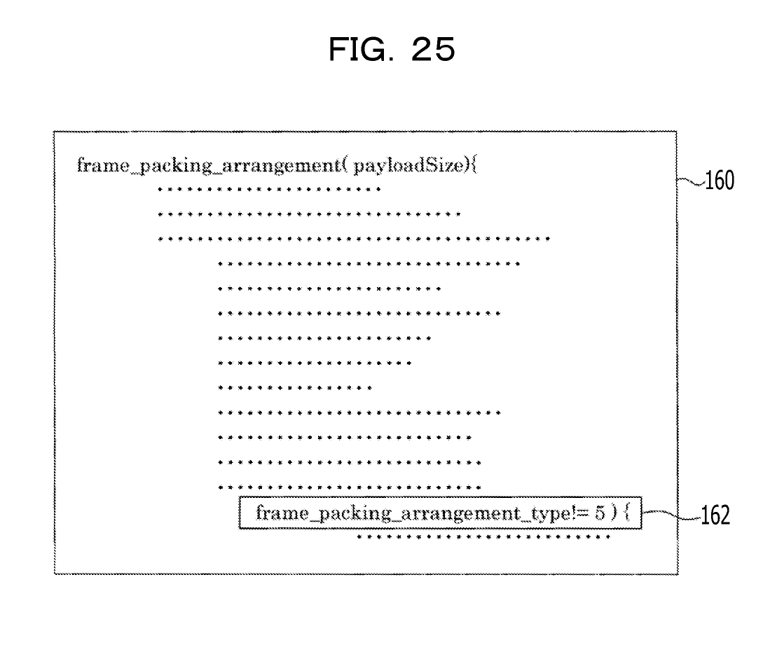

Display control processing will be described below with reference to FIGS. 21 through 25. FIG. 21 is a flowchart illustrating an example of display control processing. FIG. 22 is a flowchart illustrating an example of 2D/3D image switching processing. FIG. 23 is a flowchart illustrating an example of 3D image extracting processing and display processing. FIGS. 24A through 24C illustrate examples of identification information contained in 3D image information. FIG. 25 illustrates another example of identification information contained in 3D image information. The processing contents and the processing procedures illustrated in FIGS. 21 through 25 are examples only, and the disclosure is not restricted to those.

The display control processing is an example of a display control method according to an aspect of the present disclosure, and is executed by a display control program for the PC 20. In this display control processing, when the filter panel 22 that allows 3D images to pass therethrough is attached to the display unit 24, the display unit 24 shifts the display mode to the 3D image display mode. When the filter panel 22 is not attached or removed from the display unit 24, the display unit 24 performs processing in the 2D image display mode.

In the display control processing illustrated in FIG. 21, in step S11, monitoring processing for the attachment/detachment of the filter panel 22 to or from the display unit 24 is performed. This monitoring processing may be performed by detecting the attachment/detachment state of the filter panel 106 by using the switch 102. The attachment/detachment of the filter panel 22 may be detected by detecting the changing of the switch 102 accompanying the slide operation of the lock slider 37.

Then, in step S12, image extracting processing is performed in accordance with the attachment/detachment state of the filter panel 22 obtained through the monitoring result. For example, if the filter panel 22 is attached, 3D images are extracted from image information stored in the data storage section 142 of the PC 20. If the filter panel 22 is not attached, 2D images are extracted from the image information.

In step S13, the extracted image information is displayed on the LCD unit 32 of the display unit 24.

In the above-described display control processing, steps S11 through S13 are repeated, and when the attachment of the filter panel 22 is detected, the interrupt event generator 112 shifts the display mode to the 3D image display mode as interrupt processing.

Execution Processing of 2D/3D Image Switching Program

The execution processing, illustrated in FIG. 22, of the 2D/3D image switching program is performed, for example, in the monitoring processing for the attachment/detachment of the filter panel 22 in step S11.

In step S21, detecting processing for the depression of the switch 102 is performed so as to monitor whether the switch 102 has been changed by the attachment/detachment operation of the filter panel 22. If a detection signal is output as a result of detecting the depression of the switch 102, in step S22, the logic circuit 104 performs matching processing, such as chattering elimination. Then, in step S23, the detection signal is received by the I/O 106 of the chip set 138. Upon receiving this detection signal, in step S24, the CPU 108 starts the 2D/3D switching program.

3D Image Extracting Processing and Display Processing

The 3D image extracting processing and image display processing illustrated in FIG. 23 is started, for example, when the 2D/3D switching program is started.

In order to start 3D image display processing, in step S31, it is first determined whether the PC 20 has shut down. If the operation of the PC 20 is to finish or the user has performed an operation to finish displaying images (YES in step S31), the image display processing is terminated. If image display processing is continuously performed or if image display processing is to be newly started (NO in step S31), the process proceeds to step S32 to determine, by referring to the attachment/detachment monitoring result, whether the filter panel 22, which is a naked-eye 3D filter, is set in the display unit 24.

If a naked-eye 3D filter is set in the display unit 24 (YES in step S32), i.e., if the filter panel 22 is attached to the LCD unit 32, the process proceeds to step S33 in which the display mode is shifted to the 3D image display mode so as to extract 3D images. It is then determined in step S33 whether an identifier indicating 3D images is contained in identification information included in the image information. If it is determined that an identifier is contained in the image information (YES in step S33), the image information is found to be 3D image information, and in step S34, image display is performed. If there is no such an identifier (NO in step S33), it is determined that the image information is not 3D image information, and in step S36, the images are cut, and more specifically, processing is performed so that image information stored in the image data storage 122 is not displayed on the LCD unit 32.

If images are cut in step S36, an indication that there is no image information corresponding to the attachment/detachment state of the filter panel 22 or an instruction instructing the user to attach or detach the filter panel 22 may be displayed on the display unit 24.

If the filter panel 22 is not set (NO in step S32), display processing is performed in the 2D image display mode. Then, in step S35, it is determined whether an identifier indicating 3D images is contained in the image information. If such an identifier is contained in the image information (YES in step S35), the image information does not match the display mode, and the process proceeds to step S36 in which the images are cut and are not displayed (step S36). If such an identifier is not contained in the image information (NO in step S35), it is determined that the selected image information is 2D image information, and in step S34, the images are displayed on the display unit 24.

A determination regarding whether an identifier indicating 3D images is contained may be made, as illustrated in FIG. 24A, for example, by referring to identification information 150 contained in image information. A determination regarding whether the identification information 150 is 3D image information may be made by determining whether specific user data 152 is contained in the identification information 150. Then, by referring to specific format data 154 illustrated in FIG. 24B contained in the specific user data 152, it is determined whether an identifier 156 illustrated in FIG. 24C is described in the specific format data 154.

Alternatively, a determination regarding whether an identifier indicating 3D images is contained may be made by determining whether a specific identifier 162 is contained in identification information 160 illustrated in FIG. 25. Those pieces of identification information 150 and 160 are examples of a data structure indicating identification information according to the image display processing standards. Accordingly, the identification information is not restricted to the contents illustrated in FIGS. 24A through 25. A determination regarding whether images to be displayed are 3D images may be made in accordance with the standards of the image display processing to be executed or the type of image display format.

With this configuration, a filter panel that implements 3D display is configured to be attachable and detachable, and then, the attachment/detachment state of the filter panel is monitored. When the filter panel is attached, 3D images may be viewed, and when the filter panel is not attached, 2D images may be viewed. 2D images and 3D images may be switched in accordance with a result of detecting the attachment/detachment state of the filter panel, which also makes it possible to display images suitable for the state of the display unit. Moreover, since the holding unit for the filter panel and the slider for depressing the switch are integrally formed, the switch is reliably depressed when the filter panel is attached or detached, thereby securely performing 2D/3D switching processing.

### Advantages and Features of First Embodiment and Second Embodiment

(1) The PC 20 is an example of a display apparatus, a display control apparatus, or an electronic apparatus. The PC 20 includes the display unit 24 and the naked-eye 3D filter panel 22 which is attachable to and detachable from the front side of the display unit 24.

(2) The filter panel 22 is horizontally fixed to the LCD unit 32 of the display unit 24, and thus, the bottom side of the filter panel 22 is placed on the mount 66 of the holding member 60 of the LCD unit 32. Further, the lock slider 37 for holding the filter panel 22 is set at both ends of the top portion of the frame 50.

(3) The tabs 34 used for the attachment/detachment of the filter panel 22 are provided to the filter panel 22. The tabs 34 are integrally formed with the tab panel 70 disposed at the front side of the filter panel 22, thereby maintaining the strength of the filter panel 22 and improving the quality of the external appearance.

(4) The PC 20 monitors the attachment/detachment of the filter panel 22, and then switches between 3D and 2D display modes in accordance with the attachment/detachment state, for example, the PC 20 extracts an application that may be viewed or switches to such an application.

(5) In the display apparatus, the display control apparatus, and the electronic apparatus, easy attachment/detachment of a naked-eye 3D filter is implemented without the need to adjust the setting position of the filter with respect to the display unit, thereby easily switching between 3D images and 2D images. Then, in accordance with the attachment/detachment of the 3D filter, a 3D image viewing application, for example, may be started.

(6) In the PC 20, the frame 50 is set around the periphery of the front side of the LCD unit 32. Then, the projection 64 for holding the filter panel 22 is formed on the bottom frame 58 of the frame 50, and the filter panel 22 is placed in the groove (mount) at the back of the projection 64. Additionally, the movable lock slider 37 having the lock 38 at the forward end thereof is formed on each of the side (left and right) frames 54 and 56, and fits into the opening 36 formed in the tab 34 of the filter panel 22, thereby retaining the filter panel 22. When removing the filter panel 22, the user holds the tab 34 and depresses the lock 38 so as to release the locking state of the filter panel 22. Additionally, the attachment/detachment detector is operated in accordance with the depression of the lock 38, thereby reliably switching the image providing unit to the 2D display mode or the 3D display mode.

(7) The filter panel 22 is placed on the mount 66 of the holding member 60 that holds the LCD unit 32. In the attachment/detachment operation for the filter panel 22, after the bottom side of the filter panel 22 is placed on the mount 66, the top side of the filter panel 22 is pivoted toward the LCD unit 32 by using the bottom side as the rotational axis. With this operation, the filter panel 22, which is large and heavy, may be securely set at a predetermined position while maintaining a certain degree of levelness, and may be placed in parallel with the LCD unit 32.

### Other Embodiments

(1) In the above-described embodiments, the PC 20 has been described as an example of a display apparatus, a display control apparatus, or an electronic apparatus. However, another apparatus may be applied to the present disclosure as long as it includes a display unit that may display 2D or 3D images and allows a filter panel to be attached to or detached from the display unit, and also includes an image providing unit that detects the attachment/detachment of the filter panel so as to switch the image display mode in accordance with the attachment/detachment of the filter panel.

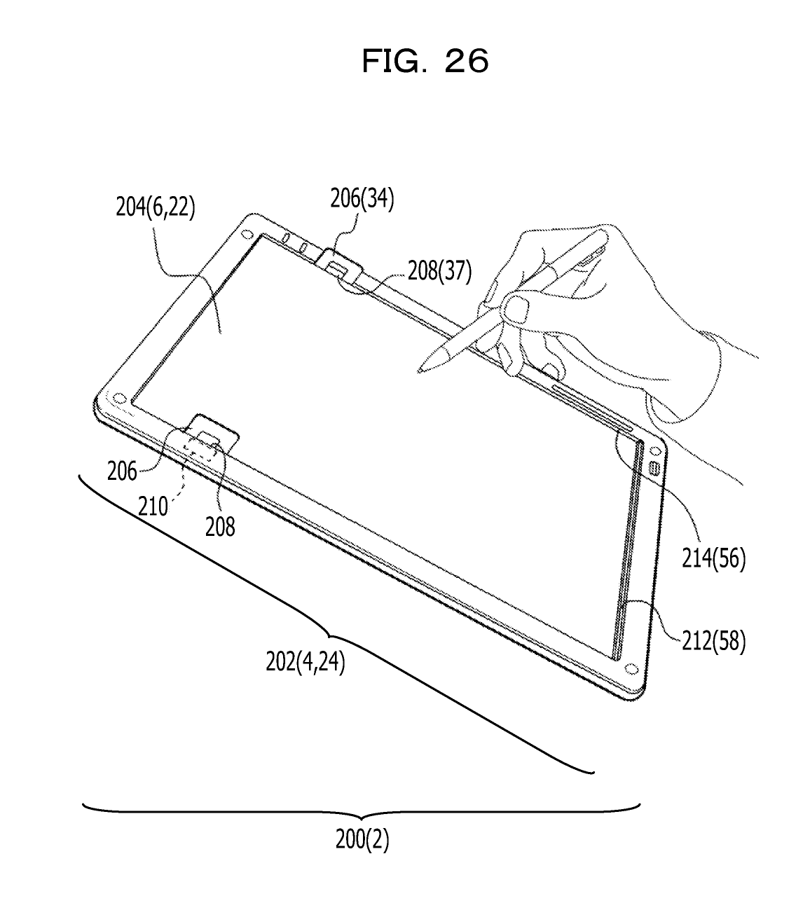

For example, a so-called tablet personal digital assistant (PDA) 200 may be used, as illustrated in FIG. 26. The PDA 200 includes a filter panel 204 that is attachable to and detachable from a display unit 202 having an operation panel. Tabs 206 are formed for the filter panel 204, as in the above-described tabs, and lock sliders 208 set for the PDA 200 are partially engaged with the tabs 206.

Within the casing of the PDA 200, attachment/detachment detectors 210 and a bottom frame 212 that stops the movement of the filter panel 204 are provided. The lock sliders 208 are formed on side frames 214, and are operated to slide when the filter panel 204 is attached or detached. As described above, the attachment/detachment detectors may detect the attachment/detachment of the filter panel 204 by utilizing the sliding operation of the lock sliders 208. Alternatively, the attachment/detachment detectors may directly detect the attachment/detachment state of the filter panel 204 by using a sensor, for example.

The PDA 200 may extract 2D images or 3D images in accordance with an attachment/detachment detection result obtained by the attachment/detachment detectors 210, thereby switching the image display mode.

As a display apparatus, a display control apparatus, or an electronic apparatus that may display 3D images, a television receiver, a game machine, or a cellular telephone may be used.

(2) In the above-described embodiments, the PC main body 26 is used as the image providing unit for providing images to the display apparatus. However, the image providing unit is not restricted to this, and may be a player connected to the display apparatus so as to play back 2D images and 3D images. Alternatively, the image providing unit may be an electronic apparatus that may play back one of 2D images or 3D images. Then, in accordance with a result of detecting the attachment/detachment of the filter panel from the display apparatus, a determination may be made whether the playback function of the electronic apparatus is suitable for the attachment/detachment state of the display unit 24, and information indicating the result may be supplied. For example, it is now assumed that an electronic apparatus without a 3D image playback function is connected to the display apparatus 2. In this case, if the filter panel 22 is attached to the LCD unit 32, the display apparatus 2 may cut images or may display information indicating that the connected electronic apparatus is not suitable for the playback operation.

(3) In the above-described embodiment, in accordance with a result of detecting the attachment/detachment of the filter panel, 2D images or 3D images are displayed, or a list of image information that may be displayed is displayed. However, even if the filter panel 22 is attached to the display unit 24, the display unit 24 may also display 2D images. In this case, among image data stored in the image data storage 122, the PC 20 may display image data which has been extracted in accordance with the attachment/detachment detection result as optimal image data, and may display other image data as image data that may be viewed.

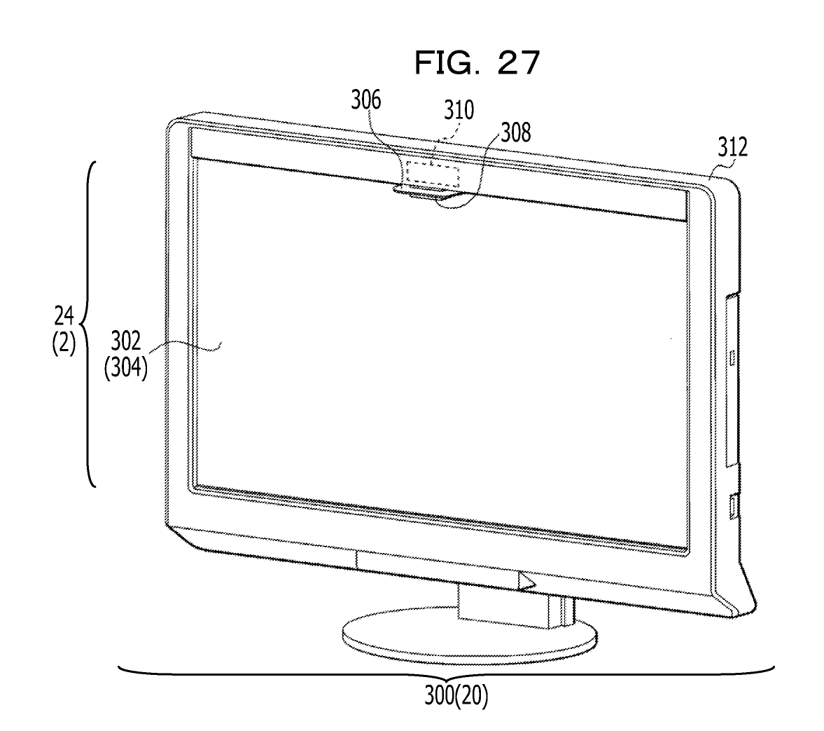

(4) The lock sliders 37 for retaining the filter panel 22 are set on the side frames 54 and 56. However, they may be set at different positions. In a PC 300 illustrated in FIG. 27, a filter panel 302 is retained to a LCD unit 304 at the top portion of the LCD unit 304. A tab 306 is provided at the central portion of the top side of the filter panel 302, and a lock slider 308 and an attachment/detachment detector 310 may be set for a casing 312 at positions corresponding to the tab 306.

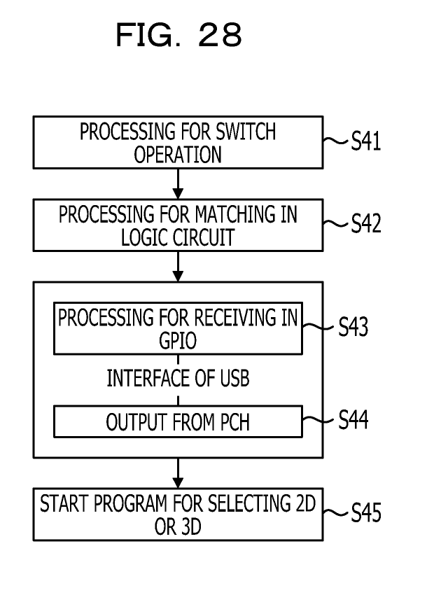

(5) If the display unit 24 and the PC main body 26 are connected via a universal serial bus (USB) or are USB connected in a virtual manner, the PC 20 may use a USB interface in the 2D/3D image switching processing. For example, as illustrated in FIG. 28, the CPU 108 of the PC 20 may receive an attachment/detachment detection signal which has passed through the logic circuit 104 by a GPIO of a microcomputer (step S43) and may output this signal via a platform controller hub (PCH) contained in the chip set (step S44). In FIG. 28, steps S41, S42, and S45 may be executed similarly to steps S21, S22, and S24, respectively, of FIG. 22, and an explanation thereof is thus omitted. With this configuration, advantages similar to those of the above-described embodiment may be obtained.

Concerning embodiments including the above-described embodiments, the following appendixes may be disclosed. However, the following appendixes do not restrict the present disclosure.

The preferred embodiments of the display apparatus, display control apparatus, display control method, and electronic apparatus have been described as above. However, it is not intended to restrict the present disclosure to the precise forms disclosed. It is apparent that various modifications and changes may be made by those who skilled in the art within the spirit of the disclosure described in the embodiments and claims, and such modifications and changes are encompassed in the scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A display apparatus comprising:
a display configured to display an image in accordance with data for a three dimensional image;
a filter configured to receive the displayed image from the display and to transform the displayed image to a stereoscopic image while the displayed image transmitting through the filter, the filter being operable to be set to be attachable to and detachable from the display; and
a detector configured to detect whether the filter is set to the display or not.

2. The display apparatus according to claim 1, further comprising a panel holder configured to fix the filter in front of the display.

3. The display apparatus according to claim 1, wherein the detector includes,
a slider configured to move forward or backward when the filter is attached to or detached from the display, and
a switch configured to be operable to switch between on state and off state by a contact with the slider.

4. The display apparatus according to claim 2, wherein the panel holder includes,
a slider configured to move forward or backward when the filter is attached to or detached from the display, and
a lock configured to be formed at the slider and to be fixed to a portion of the filter so as to support the filter in front of the display.

5. The display apparatus according to claim 2, further comprising a casing configured to form a display window, the casing being disposed in front of the display,
wherein the panel holder includes,
a mount configured to support the filter, the mount being arranged in a front side of a bottom of the display,
a frame configured to include a projection formed along a side of the display and along the display window so as to form a space between a front side of the display and the casing to prevent the filter from moving toward the display window.

6. The display apparatus according to claim 3, wherein the slider is formed on the frame.

7. A display control apparatus comprising:
a filter configured to receive an image displayed by a display and to transform the received image to a stereoscopic image while the received image transmitting through the filter, the filter being arranged in front of the display and being operable to be set to be attachable to and detachable from the display, the received image being displayed in accordance with first image data for a three dimensional image;
a detector configured to detect whether the filter is set to the display or not;
a controller configured to shift a mode of the display to a three dimensional image display mode when the detector detects that the filter is set to the display.

8. The display control apparatus according to claim 7, further comprising an image providing device for providing image data to be displayed by the display, wherein the controller extracts the first image data from the image providing device when the detector detects that the filter is set to the display and allows the display to display the image.

9. The display control apparatus according to claim 8, wherein the controller extracts, from the image providing device, second image data other than the first image data when the detector detects that the filter is not set to the display and allows the display to display an image in accordance with the second data.

10. The display control apparatus according to claim 8, wherein the controller determines, on the basis of an identifier included in the image data, whether the image data is the first image data or not.

11. A method executed by a processer for displaying an image, the method comprising;
monitoring, by the processer, whether a filter is fixed or not in front of a display, the display being operable to display a three dimensional image in a three dimensional mode;
detecting a status in which the filter is fixed in front of the display; and
shifting a mode of the display to the three dimensional mode according to the detected status.

12. The method according to claim 11, further comprising;
extracting three dimensional image data from an image providing device when the filter is fixed in front of the display, the image providing device providing image data to be displayed by the display; and
allowing the display to display an image in accordance with the extracted three dimensional image data.

13. The method according to claim 11, further comprising;
extracting image data from the image providing device when the filter is not fixed in front of the display, the image data being other than three dimensional image data; and
allowing the display to display the image in accordance with the extracted image data.

14. The display apparatus according to claim 1, further comprising:
a controller configured to shift a mode of the display to a three dimensional image display mode when the detector detects that the filter is set to the display.
